(19) United States
(12) Patent Application Publication
(10) Pub. No.: US 2025/0243831 A1
(43) Pub. Date: Jul. 31, 2025

(54) FUEL DELIVERY SYSTEM AND METHOD FOR SPARK IGNITED ENGINES OF WORK VEHICLES

(71) Applicant: Deere & Company, Moline, IL (US)

(72) Inventors: Jeffrey L. LUBBEN, Hudson, IA (US); Ameya SANT, Pune (IN); Santosh S. KHADASARE, Pune (IN)

(73) Assignee: Deere & Company, Moline, IL (US)

(21) Appl. No.: 18/958,273

(22) Filed: Nov. 25, 2024

Related U.S. Application Data
(60) Provisional application No. 63/627,146, filed on Jan. 31, 2024.

(51) Int. Cl. F02M 31/20; F02M 37/00; F02M 37/04

(52) U.S. Cl. CPC F02M 31/205; F02M 37/0023; F02M 37/04

(57) ABSTRACT

A fuel delivery system includes a fuel tank, a primary fuel pump disposed in the fuel tank, a fuel regulator device connected with the primary fuel pump by a primary fuel delivery line, and a fuel cooler device coupled with the fuel regulator device by a fuel bypass line and with the fuel tank by a fuel return line. The fuel regulator device receives unregulated supply fuel from the primary fuel pump via the primary fuel delivery line, controls a property of the unregulated supply fuel for output as regulated fuel, and delivers the regulated fuel via a regulated fuel delivery line to a secondary fuel pump of the work vehicle. The fuel cooler device receives bypass fuel from the fuel regulator device via the fuel bypass line, cools the received bypass fuel, and delivers the cooled bypass fuel to the fuel tank via the fuel return line.

### CROSS-REFERENCE TO RELATED APPLICATION

The present application is based on and claims the benefit of U.S. Provisional Patent application Ser. No. 63/627,146, filed Jan. 31, 2024, entitled FUEL DELIVERY SYSTEM AND METHOD FOR SPARK IGNITED ENGINES OF WORK VEHICLES, Docket Number (16529-00210/P35525-US-PRO), the contents of which is hereby incorporated by reference herein in its entirety.

### FIELD OF THE DISCLOSURE

This disclosure relates to fuel delivery systems and methods and, more particularly to fuel delivery systems and methods for spark ignited engines of work vehicles.

### BACKGROUND

It is important for performance reasons to maintain the temperature of fuels in work vehicles to within selected temperature ranges based on the chemistry of the fuels being used, and their operating pressures.

It is particularly desirable to maintain the temperature of #2 diesel fuel to well below 338° C. to prevent it from boiling. Similarly, it is important to maintain the temperature of ethanol fuel to well below 78° C. to prevent it from boiling.

Some work vehicles may place additional fuel cooling requirements based on proximity of fuel tanks relative to vehicle components that may give off heat that may indirectly heat the fuel tank and correspondingly the fuel within the tank.

It is therefore desirable to provide fuel delivery systems and methods that condition the fuel stored in a tank of a work vehicle such as for example systems and methods that condition the fuel by cooling it and returning the cooled fuel to the fuel tank.

### SUMMARY

The embodiments herein are directed to fuel delivery systems and methods.

An embodiment herein is directed to a fuel delivery system for spark ignited engines of work vehicles.

An embodiment herein is directed to a fuel delivery method for spark ignited engines of work vehicles.

An embodiment herein is directed to a fuel delivery system for spark ignited engines of work vehicles wherein the fuel is cooled before delivery to the spark ignited engine.

An embodiment herein is directed to a fuel delivery method for spark ignited engines of work vehicles wherein the fuel is cooled before delivery to the spark ignited engine.

The implementations described herein provide improved fuel cooling systems and methods wherein all fuel pumped from a fuel pump disposed in a fuel tank for delivery to a spark ignited engine of a work vehicle is either fed to the spark ignited engine or returned to the fuel tank passing first through a fuel cooler device. That is, a portion of the fuel pumped from the fuel pump disposed in the fuel tank is delivered to the spark ignited engine of the work vehicle, and the remainder of the fuel pumped from the fuel pump is returned to the fuel tank passing first through the fuel cooler device.

The implementations described herein provide improved fuel cooling systems and methods wherein no fuel fed to a spark ignited engine of a work vehicle is returned to the fuel tank.

In accordance with an aspect, a fuel delivery system for a work vehicle is provided. The fuel delivery system includes a fuel tank operable to store fuel therein, a primary fuel pump disposed in the fuel tank a fuel regulator device operatively connected with the primary fuel pump by a primary fuel delivery line, and a fuel cooler device operatively coupled with the fuel regulator device by a fuel bypass line and with the fuel tank by a fuel return line. The fuel regulator device is operable to receive unregulated supply fuel delivered to the fuel regulator device from the primary fuel pump via the primary fuel delivery line, control a property of the unregulated supply fuel received from the primary fuel pump for output from the fuel regulator device as regulated fuel, and deliver the regulated fuel via a regulated fuel delivery line to a secondary fuel pump of the work vehicle. The fuel cooler device is operable to receive bypass fuel delivered to the fuel cooler device from the fuel regulator device via the fuel bypass line, cool the bypass fuel received by the fuel cooler device, and deliver the cooled bypass fuel to the fuel tank via the fuel return line.

In any of the embodiments, the fuel cooler device provides a sole source of cooling to any fuel returned to the fuel tank from the fuel delivery system and the work vehicle.

In any of the embodiments, the fuel cooler device comprises cooler tubes and a plurality of cooling fins coupled with the cooler tubes.

In any of the embodiments, the fuel regulator device is operable to deliver the regulated fuel via the regulated fuel delivery line to a secondary fuel pump of the work vehicle adapted to pressurize the regulated fuel to a working pressure adapted for direct use by a spark ignited internal combustion engine of the work vehicle.

In any of the embodiments, the fuel regulator device is operable to control a pressure of the unregulated supply fuel received from the primary fuel pump for output from the fuel regulator device to the secondary fuel pump of the vehicle as the regulated fuel.

In any of the embodiments, the fuel regulator device is operable to receive the unregulated supply fuel from the primary fuel pump at a fuel pressure of the primary fuel pump, control the pressure of the unregulated supply fuel received from the primary fuel pump for output from the fuel regulator device as the regulated fuel having a fuel pressure within an acceptable operating pressure range, deliver the regulated fuel having the pressure within the desired operating pressure range via the regulated fuel delivery line to the secondary fuel pump of the work vehicle, and deliver to the fuel cooler device all remaining portions of fuel received by the fuel regulator device that are not delivered to the secondary fuel pump of the work vehicle.

In any of the embodiments, the fuel regulator device is operable to control a flow rate of the unregulated supply fuel received from the primary fuel pump for output from the fuel regulator device to the secondary fuel pump of the vehicle as the regulated fuel.

In any of the embodiments, the fuel regulator device is operable to receive the unregulated supply fuel from the primary fuel pump at a nominal flow rate of about 160 liters per hour (lphr), control the flow rate of the unregulated supply fuel received from the primary fuel pump for output from the fuel regulator device as the regulated fuel having a desired nominal flow rate of about 60 lphr, deliver the regulated fuel having the flow rate of about 60 lphr via the regulated fuel delivery line to the secondary fuel pump of the work vehicle, and deliver to the fuel cooler device all remaining portions of fuel received by the fuel regulator device that are not delivered to the secondary fuel pump of the work vehicle.

In any of the embodiments, the fuel delivery system further comprises a fuel filter disposed in the primary fuel delivery line between the primary fuel pump and the fuel regulator device, the fuel filter being operable to filter the unregulated supply fuel delivered to the fuel regulator device from the primary fuel pump via the primary fuel delivery line.

In any of the embodiments, the fuel regulator device is disposed in the fuel tank.

In accordance with a further aspect, a work vehicle is provided including a chassis, a spark ignited internal combustion engine operatively coupled with the chassis, one or more ground engaging members configured to propel the work vehicle, a transmission system coupling the spark ignited internal combustion engine with the one or more ground engaging members, and a fuel delivery system. The fuel deliver system includes a fuel tank operable to store fuel therein, a primary fuel pump disposed in the fuel tank, a fuel regulator device operatively connected with the primary fuel pump by a primary fuel delivery line, and a fuel cooler device operatively coupled with the fuel regulator device by a fuel bypass line and with the fuel tank by a fuel return line. The fuel regulator device of the fuel delivery system of the work vehicle is operable to receive unregulated supply fuel delivered to the fuel regulator device from the primary fuel pump via the primary fuel delivery line, control a property of the unregulated supply fuel received from the primary fuel pump for output from the fuel regulator device as regulated fuel, and deliver the regulated fuel via a regulated fuel delivery line to a secondary fuel pump of the work vehicle. The fuel cooler device of the fuel delivery system of the work vehicle is operable to receive bypass fuel delivered to the fuel cooler device from the fuel regulator device via the fuel bypass line, cool the bypass fuel received by the fuel cooler device, and deliver the cooled bypass fuel to the fuel tank via the fuel return line.

In any of the embodiments, the fuel cooler device of the fuel delivery system of the work vehicle provides a sole source of cooling to any fuel returned to the fuel tank from the fuel delivery system and the work vehicle.

In any of the embodiments, the fuel cooler device of the fuel delivery system of the work vehicle comprises cooler tubes, and a plurality of cooling fins coupled with the cooler tubes.

In any of the embodiments, the fuel regulator device of the fuel delivery system of the work vehicle is operable to deliver the regulated fuel via the regulated fuel delivery line to a secondary fuel pump of the work vehicle, and the secondary fuel pump of the work vehicle is operable to pressurize the regulated fuel to a working pressure adapted for direct use by the spark ignited internal combustion engine of the work vehicle.

In any of the embodiments, the fuel regulator device of the fuel delivery system of the work vehicle is operable to control a pressure of the unregulated supply fuel received from the primary fuel pump for output from the fuel regulator device to the secondary fuel pump of the vehicle as the regulated fuel.

In any of the embodiments, the fuel regulator device of the fuel delivery system of the work vehicle is operable to receive the unregulated supply fuel from the primary fuel pump at a fuel pressure of the primary fuel pump, control the pressure of the unregulated supply fuel received from the primary fuel pump for output from the fuel regulator device as the regulated fuel having a fuel pressure within an acceptable operating pressure range, deliver the regulated fuel having the pressure within the desired operating pressure range via the regulated fuel delivery line to the secondary fuel pump of the work vehicle, and deliver to the fuel cooler device all remaining portions of fuel received by the fuel regulator device that are not delivered to the secondary fuel pump of the work vehicle.

In any of the embodiments, the fuel regulator device of the fuel delivery system of the work vehicle is operable to control a flow rate of the unregulated supply fuel received from the primary fuel pump for output from the fuel regulator device to the secondary fuel pump of the vehicle as the regulated fuel.

In any of the embodiments, the fuel regulator device of the fuel delivery system of the work vehicle is operable to receive the unregulated supply fuel from the primary fuel pump at a nominal flow rate of about 160 liters per hour (lphr), control the flow rate of the unregulated supply fuel received from the primary fuel pump for output from the fuel regulator device as the regulated fuel having a desired nominal flow rate of about 60 lphr, deliver the regulated fuel having the flow rate of about 60 lphr via the regulated fuel delivery line to the secondary fuel pump of the work vehicle, and deliver to the fuel cooler device all remaining portions of fuel received by the fuel regulator device that are not delivered to the secondary fuel pump of the work vehicle.

In any of the embodiments, the work vehicle further comprises a fuel filter disposed in the primary fuel delivery line between the primary fuel pump and the fuel regulator device, the fuel filter being operable to filter the unregulated supply fuel delivered to the fuel regulator device from the primary fuel pump via the primary fuel delivery line.

In any of the embodiments, the fuel regulator device of the fuel delivery system of the work vehicle is disposed in the fuel tank.

In any of the embodiments, the fuel tank of the work vehicle is disposed immediately adjacent to the transmission system of the work vehicle.

In any of the embodiments, the fuel tank of the work vehicle is disposed immediately adjacent and above the transmission system of the work vehicle, whereby the fuel cooler device of the fuel delivery system provides a sole source of cooling to any fuel returned to the fuel tank from the fuel delivery system and the work vehicle for cooling the fuel in the fuel tank against increases of temperature of the fuel tank caused by the immediate adjacency between the fuel tank and the transmission system of the work vehicle.

In accordance with a still further aspect, a method of conditioning fuel stored in a fuel tank of a work vehicle is provided. The method includes receiving unregulated supply fuel by a fuel regulator device via a primary fuel delivery line, the unregulated supply fuel being delivered to the fuel regulator device from a primary fuel pump disposed in the fuel tank of the work vehicle and operatively coupled with the fuel regulator device via the primary fuel delivery line. The method further includes controlling by the fuel regulator device a property of the unregulated supply fuel received from the primary fuel pump for output from the fuel regulator device as regulated fuel. The method further includes delivering by the fuel regulator device the regulated fuel via a regulated fuel delivery line to a secondary fuel pump of the work vehicle. The method further includes receiving bypass fuel by a fuel cooler device via a fuel bypass line, the bypass fuel being delivered to the fuel cooler device from the fuel regulator device via the fuel bypass line. The method further includes cooling by the fuel cooler device the bypass fuel received by the fuel cooler device. The method further includes delivering the cooled bypass fuel to the fuel tank via a fuel return line operatively coupling the fuel tank with the fuel cooler device.

In any of the embodiments of the method of conditioning fuel, the cooling by the fuel cooler device the bypass fuel received by the fuel cooler device provides a sole source of cooling to any fuel returned to the fuel tank from the fuel delivery system and the work vehicle.

In any of the embodiments of the method of conditioning fuel, the cooling the bypass fuel comprises cooling the bypass fuel using a fuel cooler device comprising cooler tubes and a plurality of cooling fins coupled with the cooler tubes.

In any of the embodiments of the method of conditioning fuel, the delivering the regulated fuel comprises delivering the regulated fuel by a fuel regulator device operable to deliver the regulated fuel via the regulated fuel delivery line to a secondary fuel pump of the work vehicle adapted to pressurize the regulated fuel to a working pressure adapted for use by a spark ignited internal combustion engine of the work vehicle.

In any of the embodiments of the method of conditioning fuel, the method further comprises controlling a pressure of the unregulated supply fuel by the fuel regulator device to control a pressure of the unregulated supply fuel received from the primary fuel pump for output from the fuel regulator device as the regulated fuel.

In any of the embodiments of the method of conditioning fuel, the method further comprises operating the fuel regulator device to receive the unregulated supply fuel from the primary fuel pump at a fuel pressure of the primary fuel pump, control the pressure of the unregulated supply fuel received from the primary fuel pump for output from the fuel regulator device as the regulated fuel having a fuel pressure within an acceptable operating pressure range, deliver the regulated fuel having the pressure within the desired operating pressure range via the regulated fuel delivery line to the secondary fuel pump of the work vehicle, and deliver to the fuel cooler device all remaining portions of fuel received by the fuel regulator device that are not delivered to the secondary fuel pump of the work vehicle.

In any of the embodiments of the method of conditioning fuel, the method further comprises controlling a flow rate of the unregulated supply fuel by the fuel regulator device to control a flow rate of the unregulated supply fuel received from the primary fuel pump for output from the fuel regulator device to the secondary fuel pump of the vehicle via the regulated fuel delivery line as the regulated fuel.

In any of the embodiments of the method of conditioning fuel, the method further comprises operating the fuel regulator device to receive the unregulated supply fuel from the primary fuel pump at a nominal flow rate of about 160 liters per hour (lphr), control the flow rate of the unregulated supply fuel received from the primary fuel pump for output from the fuel regulator device as the regulated fuel having a desired nominal flow rate of about 60 lphr, deliver the regulated fuel having the flow rate of about 60 lphr via the regulated fuel delivery line to the secondary fuel pump of the work vehicle, and deliver to the fuel cooler device all remaining portions of fuel received by the fuel regulator device that are not delivered to the secondary fuel pump of the work vehicle.

In any of the embodiments of the method of conditioning fuel, the method further comprises using a fuel filter to filter the unregulated supply fuel delivered to the fuel regulator device from the primary fuel pump via the primary fuel delivery line.

In any of the embodiments of the method of conditioning fuel, the receiving the unregulated supply fuel by the fuel regulator device comprises receiving the unregulated supply fuel by a fuel regulator device disposed in the fuel tank.

In accordance with an aspect, a fuel delivery system for a work vehicle is provided. The fuel delivery system includes a fuel tank operable to store fuel therein, a primary fuel pump disposed in the fuel tank, a fuel regulator device operatively connected with the primary fuel pump by a primary fuel delivery line, and an auxiliary cooling system in communication with a cooling coil that is disposed in the fuel tank. The fuel regulator device is operable to receive unregulated supply fuel delivered to the fuel regulator device from the primary fuel pump via the primary fuel delivery line, control a property of the unregulated supply fuel received from the primary fuel pump for output from the fuel regulator device as regulated fuel, and deliver the regulated fuel via a regulated fuel delivery line to a secondary fuel pump of the work vehicle.

In any of the implementations of the fuel delivery system, wherein the auxiliary cooling system in communication with the cooling coil is operable for regulating the temperature of the fuel to within desired temperature bounds including for example to cool the fuel in the tank to a desired temperature.

In any of the implementations of the fuel delivery system, the coil may circulate a fluid such as a gas or a fluid to absorb heat from the fuel in the tank into the fluid circulating between the coil and the auxiliary cooling system.

In any of the implementations of the fuel delivery system, the circulating fluid may be a refrigerant.

In any of the implementations of the fuel delivery system, the circulating fluid may be glycol or any other liquid for absorbing heat from the fuel.

In accordance with an aspect, a fuel delivery system for a work vehicle is provided. The fuel delivery system includes a fuel tank operable to store fuel therein, a primary fuel pump disposed in the fuel tank, a fuel regulator device operatively connected with the primary fuel pump by a primary fuel delivery line, a fuel cooler device operatively coupled with the fuel regulator device by a fuel bypass line and with the fuel tank by a fuel return line, and an auxiliary cooling control system. The fuel regulator device is operable to receive unregulated supply fuel delivered to the fuel regulator device from the primary fuel pump via the primary fuel delivery line, control a property of the unregulated supply fuel received from the primary fuel pump 30 for output from the fuel regulator device as regulated fuel, and deliver the regulated fuel via a regulated fuel delivery line to a secondary fuel pump of the work vehicle. The fuel cooler device is operable to receive bypass fuel delivered to the fuel cooler device from the fuel regulator device via the fuel bypass line, cool the bypass fuel received by the fuel cooler device to generate cooled bypass fuel, and deliver the cooled bypass fuel to the fuel tank via the fuel return line. The auxiliary cooling control system of the fuel delivery system includes a control unit that is powered by a battery, and that is in operative communication with the fuel pump, and a sensor, wherein the control unit comprises a processor device in operative communication with a non-transient memory device that stores control logic, wherein the processor device may execute the control logic to determine a temperature of the fuel stored within the tank and to selectively energize the fuel pump to circulate fuel through the fuel cooler device based on the determined temperature.

In any of the implementations of the fuel delivery system, the processor device may execute the control logic to selectively energize the fuel pump to circulate fuel through the fuel cooler device based on the determined temperature being above a predetermined temperature threshold.

In any of the implementations of the fuel delivery system, the processor device may execute the control logic to selectively energize the fuel pump to circulate fuel through the fuel cooler device regardless of whether the spark ignited internal combustion engine of the work vehicle is operating.

In any of the implementations of the fuel delivery system, the processor device may execute the control logic to selectively energize the fuel pump to circulate fuel through the fuel cooler device independently of any of the functions of the associated work vehicle.

### BRIEF DESCRIPTION OF THE DRAWINGS

In the accompanying drawings which are incorporated in and constitute a part of the specification, implementations of the disclosure are illustrated, which, together with the general descriptions given above, and the detailed description given below, serve to exemplify the implementations of this disclosure.

FIG. 1 is a schematic illustration of a fuel delivery system in accordance with an example embodiment of the present disclosure.

FIG. 2 is a schematic illustration of a fuel delivery system in accordance with an example embodiment of the present disclosure.

FIG. 3 is a schematic illustration of a fuel delivery system in accordance with an example embodiment of the present disclosure.

FIG. 4 is a schematic illustration of a work vehicle having a fuel delivery system in accordance with an example embodiment of the present disclosure.

FIG. 5 is a schematic illustration of a work vehicle having a fuel delivery system in accordance with an example embodiment of the present disclosure.

FIG. 6 is a schematic illustration of a work vehicle having a fuel delivery system in accordance with an example embodiment of the present disclosure.

FIG. 7 is a schematic illustration of a fuel delivery system in accordance with an example embodiment of the present disclosure.

FIG. 8 is a schematic illustration of a fuel delivery system in accordance with an example embodiment of the present disclosure.

FIG. 9 is a schematic illustration of a fuel tank of a fuel delivery system in accordance with an example embodiment of the present disclosure.

FIG. 10 is a flow diagram illustrating a functional flow of a method of conditioning fuel stored in a fuel tank in accordance with an example embodiment of the present disclosure.

### DETAILED DESCRIPTION

For promoting an understanding of the principles of the present disclosure, reference will now be made to the implementations described herein and illustrated in the drawings and specific language will be used to describe the same. It will nevertheless be understood that no limitation of the scope of the present disclosure is thereby intended, such alterations and further modifications in the illustrated devices and methods, and such further applications of the principles of the present disclosure as illustrated therein being contemplated as would normally occur to one skilled in the art to which the present disclosure relates.

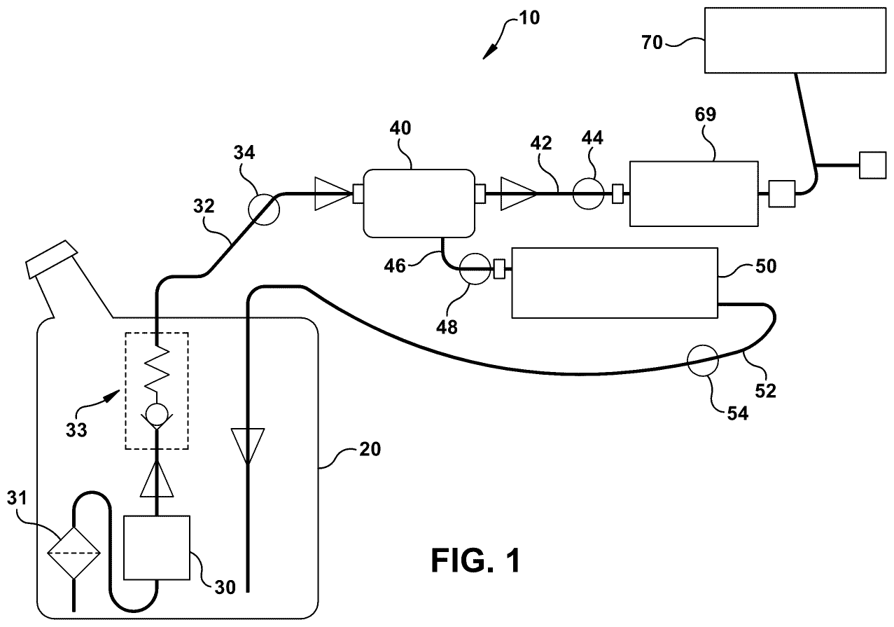

Referring now to FIG. 1, there is shown a fuel delivery system 10 for a work vehicle 100 in accordance with an illustrative embodiment of the present disclosure. As illustrated the fuel delivery system 10 includes a fuel tank 20, a primary fuel pump 30 disposed in the fuel tank 20, a fuel regulator device 40, and a fuel cooler device 50. The fuel tank 20 is operable to store fuel therein, and the primary fuel pump 30 is disposed in the fuel tank 20. It is to be appreciated that in any of the example embodiments described herein that the fuel stored in the fuel tank 20 may be any type of fuel including and without limitation a methanol blended fuel, an ethanol blended fuel, a propanol blended fuel, a butanol blended fuel, or any other type of fuel including any type of biofuels or combination of fuels and or fuel additives. The fuel may be for example E93 type fuel or E98 type fuel to name a few commonly available fuel types.

In the example embodiment illustrated the fuel regulator device 40 is operatively connected with the primary fuel pump 30 by a primary fuel delivery line 32. It is to be appreciated that the fuel may be #2 diesel fuel, ethanol fuel, or the like.

In the example embodiment the fuel delivery system includes a fuel filter 31 operatively coupled with the primary fuel pump 30 for filtering the fuel as it flows from the fuel tank 20 and into the primary fuel pump 30. In addition, a check valve 33 is disposed in the primary fuel delivery line 32 between the primary fuel pump 30 and the fuel regulator device 40. The check valve 33 helps to prevent fuel from flowing in a reverse direction through the primary fuel pump 30 and back into the fuel tank 20.

In the example embodiment the fuel regulator device 40 is operable to receive unregulated supply fuel 34 delivered to the fuel regulator device 40 from the primary fuel pump 30 via the primary fuel delivery line 32. The fuel regulator device 40 is further operable to control a property of the unregulated supply fuel 34 received from the primary fuel pump 30 for output from the fuel regulator device 40 as regulated fuel 44. The fuel regulator device 40 is further operable to deliver the regulated fuel 44 via a regulated fuel delivery line 42 to a secondary fuel pump 70 of the work vehicle 100. As shown an additional fuel filter 69 may be disposed in the regulated fuel delivery line 42 between the fuel regulator device 40 and the secondary fuel pump 70.

As shown, the fuel cooler device 50 is operatively coupled with the fuel regulator device 40 by a fuel bypass line 46 and with the fuel tank 20 by a fuel return line 52.

In the example embodiment the fuel cooler device 50 is operable to receive bypass fuel 48 delivered to the fuel cooler device 50 from the fuel regulator device 40 via the fuel bypass line 46. In the example embodiment the fuel cooler device 50 is further operable to cool the bypass fuel 48 received by the fuel cooler device 50 to generate cooled bypass fuel 48, and to deliver the cooled bypass fuel 48 to the fuel tank 20 via the fuel return line 52.

It is to be appreciated that in the example embodiment illustrated, the fuel cooler device 50 provides a sole source of cooling to any fuel returned to the fuel tank 20 from the fuel delivery system 10 and the work vehicle 100.

In an example embodiment, the fuel cooler device 50 may comprise cooler tubes and a plurality of cooling fins coupled with the cooler tubes. In that way, the fuel cooler device 50 may cool the fuel passing therethrough by the external flow of air passing over and/or through the cooling fins.

In the example embodiment the fuel regulator device 40 is operable to deliver the regulated fuel 44 via the regulated fuel 44 delivery line to a secondary fuel pump 70 of the work vehicle 100 adapted to pressurize the regulated fuel 44 to a working pressure adapted for direct use by a spark ignited internal combustion engine 120 of the work vehicle 100.

In an example embodiment the fuel regulator device 40 is operable to control a pressure of the unregulated supply fuel 34 received from the primary fuel pump 30 for output from the fuel regulator device 40 to the secondary fuel pump 70 of the work vehicle 100 via the regulated fuel 44 delivery line as the regulated fuel 44. In this regard the fuel regulator device 40 is operable to receive the unregulated supply fuel 34 from the primary fuel pump 30 at a fuel pressure of the primary fuel pump and control the pressure of the unregulated supply fuel 34 received from the primary fuel pump 30 for output from the fuel regulator device 40 as the regulated fuel 44 having a fuel pressure within an acceptable operating pressure range. In this regard the fuel regulator device 40 is further operable to deliver the regulated fuel 44 having the pressure within the desired operating pressure range via the regulated fuel delivery line 42 to the secondary fuel pump 70 of the work vehicle 100, and to deliver to the fuel cooler device 50 all remaining portions of fuel received by the fuel regulator device 40 that are not delivered to the secondary fuel pump 70 of the work vehicle 100.

In an example embodiment the fuel regulator device 40 is operable to control a flow rate of the unregulated supply fuel 34 received from the primary fuel pump 30 for output from the fuel regulator device 40 to the secondary fuel pump 70 of the work vehicle 100 via the regulated fuel 44 delivery line as the regulated fuel 44. In this regard the fuel regulator device 40 is operable to receive the unregulated supply fuel 34 from the primary fuel pump 30 at a flow rate of about 160 liters per hour (lphr) and control the flow rate of the unregulated supply fuel 34 received from the primary fuel pump 30 for output from the fuel regulator device 40 as the regulated fuel 44 having a flow rate of about 60 lphr. In this regard the fuel regulator device 40 is further operable to deliver the regulated fuel 44 having the flow rate of about 60 lphr via the regulated fuel delivery line 42 to the secondary fuel pump 70 of the work vehicle 100, and deliver to the fuel cooler device 50 all remaining portions of fuel received by the fuel regulator device 40 that are not delivered to the secondary fuel pump 70 of the work vehicle 100.

In an example embodiment the fuel regulator device 40 is operable to control a pressure and flow rate of the unregulated supply fuel 34 received from the primary fuel pump 30 for output from the fuel regulator device 40 to the secondary fuel pump 70 of the work vehicle 100 via the regulated fuel 44 delivery line as the regulated fuel 44. In this regard the fuel regulator device 40 is operable to receive the unregulated supply fuel 34 from the primary fuel pump 30 at a pressure of the primary fuel pump and a flow rate of about 160 liters per hour (lphr) and control the pressure and flow rate of the unregulated supply fuel 34 received from the primary fuel pump 30 for output from the fuel regulator device 40 as the regulated fuel 44 having a pressure within a desired operating pressure range and a flow rate of about 60 lphr. In this regard the fuel regulator device 40 is further operable to deliver the regulated fuel 44 having a pressure within the desired operating pressure range and flow rate of about 60 lphr via the regulated fuel delivery line 42 to the secondary fuel pump 70 of the work vehicle 100, and deliver to the fuel cooler device 50 all remaining portions of fuel received by the fuel regulator device 40 that are not delivered to the secondary fuel pump 70 of the work vehicle 100.

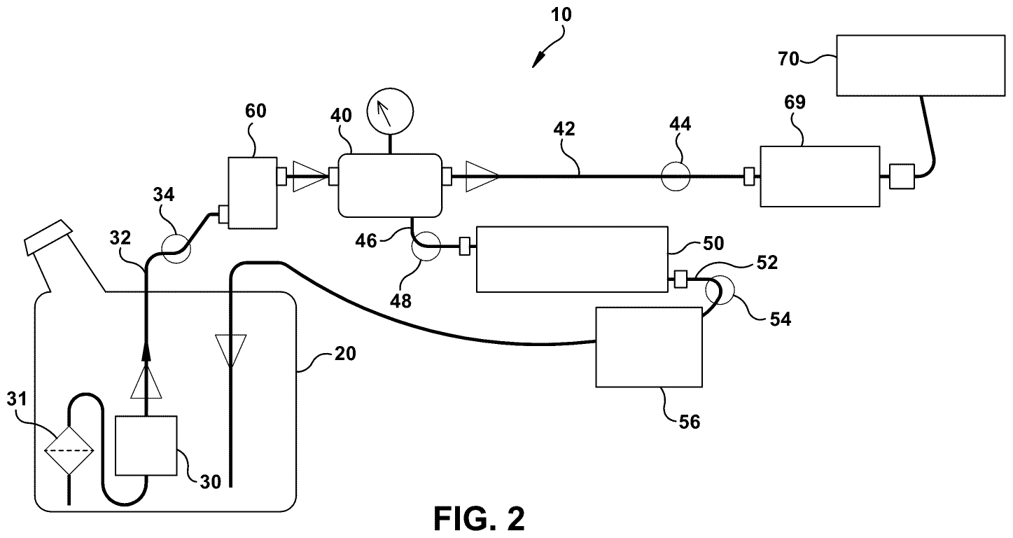

Referring next to FIG. 2, there is shown a fuel delivery system 10 for a work vehicle 100 in accordance with an illustrative embodiment of the present disclosure. As illustrated the fuel delivery system 10 includes a fuel tank 20, a primary fuel pump 30 disposed in the fuel tank 20, a fuel regulator device 40, and a fuel cooler device 50. The fuel tank 20 is operable to store fuel therein, and the primary fuel pump 30 is disposed in the fuel tank 20. The fuel regulator device 40 is operatively connected with the primary fuel pump 30 by a primary fuel delivery line 32. It is to be appreciated that the fuel may be #2 diesel fuel, ethanol fuel, or the like.

In the example embodiment the fuel regulator device 40 is operable to receive unregulated supply fuel 34 delivered to the fuel regulator device 40 from the primary fuel pump 30 via the primary fuel delivery line 32. The fuel regulator device 40 is further operable to control a property of the unregulated supply fuel 34 received from the primary fuel pump 30 for output from the fuel regulator device 40 as regulated fuel 44. The fuel regulator device 40 is further operable to deliver the regulated fuel 44 via a regulated fuel 44 delivery line to a secondary fuel pump 70 of the work vehicle 100.

As shown an additional fuel filter 69 may be disposed in the regulated fuel delivery line 42 between the fuel regulator device 40 and the secondary fuel pump 70.

In the example embodiment the fuel delivery system includes a fuel filter 31 operatively coupled with the primary fuel pump 30 for filtering the fuel as it flows from the fuel tank 20 and into the primary fuel pump 30. In addition, a check valve (not shown in FIG. 2) may be disposed in the primary fuel delivery line 32 between the primary fuel pump 30 and the fuel regulator device 40. The check valve when placed in this manner helps to prevent fuel from flowing in a reverse direction through the primary fuel pump 30 and back into the fuel tank 20.

As shown, the fuel cooler device 50 is operatively coupled with the fuel regulator device 40 by a fuel bypass line 46 and with the fuel tank 20 by a fuel return line 52.

In the example embodiment the fuel cooler device 50 is operable to receive bypass fuel 48 delivered to the fuel cooler device 50 from the fuel regulator device 40 via the fuel bypass line 46. In the example embodiment the fuel cooler device 50 is further operable to cool the bypass fuel 48 received by the fuel cooler device 50 to generate cooled bypass fuel 48, and to deliver the cooled bypass fuel 48 to the fuel tank 20 via the fuel return line 52.

It is to be appreciated that in the example embodiment illustrated, the fuel cooler device 50 provides a sole source of cooling to any fuel returned to the fuel tank 20 from the fuel delivery system 10 and the work vehicle 100.

In an example embodiment, the fuel cooler device 50 may comprise cooler tubes and a plurality of cooling fins coupled with the cooler tubes. In that way, the fuel cooler device 50 may cool the fuel passing therethrough by the external flow of air passing over and/or through the cooling fins.

In the example embodiment the fuel regulator device 40 is operable to deliver the regulated fuel 44 via the regulated fuel 44 delivery line to a secondary fuel pump 70 of the work vehicle 100 adapted to pressurize the regulated fuel 44 to a working pressure adapted for direct use by a spark ignited internal combustion engine 120 of the work vehicle 100.

In an example embodiment the fuel regulator device 40 is operable to control a pressure of the unregulated supply fuel 34 received from the primary fuel pump 30 for output from the fuel regulator device 40 to the secondary fuel pump 70 of the work vehicle 100 via the regulated fuel 44 delivery line as the regulated fuel 44. In this regard the fuel regulator device 40 is operable to receive the unregulated supply fuel 34 from the primary fuel pump 30 at a fuel pressure of the primary fuel pump and control the pressure of the unregulated supply fuel 34 received from the primary fuel pump 30 for output from the fuel regulator device 40 as the regulated fuel 44 having a fuel pressure within an acceptable operating pressure range. In this regard the fuel regulator device 40 is further operable to deliver the regulated fuel 44 having the pressure within the desired operating pressure range via the regulated fuel delivery line 42 to the secondary fuel pump 70 of the work vehicle 100, and to deliver to the fuel cooler device 50 all remaining portions of fuel received by the fuel regulator device 40 that are not delivered to the secondary fuel pump 70 of the work vehicle 100.

In an example embodiment the fuel regulator device 40 is operable to control a flow rate of the unregulated supply fuel 34 received from the primary fuel pump 30 for output from the fuel regulator device 40 to the secondary fuel pump 70 of the work vehicle 100 via the regulated fuel 44 delivery line as the regulated fuel 44. In this regard the fuel regulator device 40 is operable to receive the unregulated supply fuel 34 from the primary fuel pump 30 at a flow rate of about 160 liters per hour (lphr) and control the flow rate of the unregulated supply fuel 34 received from the primary fuel pump 30 for output from the fuel regulator device 40 as the regulated fuel 44 having a flow rate of about 60 lphr. In this regard the fuel regulator device 40 is further operable to deliver the regulated fuel 44 having the flow rate of about 60 lphr via the regulated fuel delivery line 42 to the secondary fuel pump 70 of the work vehicle 100, and deliver to the fuel cooler device 50 all remaining portions of fuel received by the fuel regulator device 40 that are not delivered to the secondary fuel pump 70 of the work vehicle 100.

In an example embodiment the fuel regulator device 40 is operable to control a pressure and flow rate of the unregulated supply fuel 34 received from the primary fuel pump 30 for output from the fuel regulator device 40 to the secondary fuel pump 70 of the work vehicle 100 via the regulated fuel 44 delivery line as the regulated fuel 44. In this regard the fuel regulator device 40 is operable to receive the unregulated supply fuel 34 from the primary fuel pump 30 at a pressure of the primary fuel pump and a flow rate of about 160 liters per hour (lphr) and control the pressure and flow rate of the unregulated supply fuel 34 received from the primary fuel pump 30 for output from the fuel regulator device 40 as the regulated fuel 44 having a pressure within a desired operating pressure range and a flow rate of about 60 lphr. In this regard the fuel regulator device 40 is further operable to deliver the regulated fuel 44 having a pressure within the desired operating pressure range and flow rate of about 60 lphr via the regulated fuel delivery line 42 to the secondary fuel pump 70 of the work vehicle 100, and deliver to the fuel cooler device 50 all remaining portions of fuel received by the fuel regulator device 40 that are not delivered to the secondary fuel pump 70 of the work vehicle 100.

In the example embodiment illustrated in FIG. 2 the fuel delivery system 10 further includes a fuel filter 60 disposed in the primary fuel delivery line 32 between the primary fuel pump 30 and the fuel regulator device 40. The fuel filter 60 is operable to filter the unregulated supply fuel 34 delivered to the fuel regulator device 40 from the primary fuel pump 30 via the primary fuel delivery line 32.

In the example embodiment the fuel delivery system further includes a fuel characteristic sensor 56 for sensing a property of the fuel and generating a signal representative of the sensed property for delivery to an associated control system and/or device. In an example embodiment the fuel characteristic sensor 56 may comprise a flex fuel sensor for sensing a percentage of alcohol in the fuel and generating a signal representative of the sensed percentage of alcohol in the fuel for delivery to an associated control system and/or device. The sensor 56 may sense a percentage of methanol in the fuel, a percentage of ethanol in the fuel, a percentage of propanol in the fuel, a percentage of butanol in the fuel, or any other property or combination of properties of additives in the fuel. The fuel characteristic sensor 56 may be configured to determine for example whether the fuel is E93 type fuel or E98 type fuel for example and deliver a signal representative thereof to engine control device for optimizing operation of the work vehicle engine.

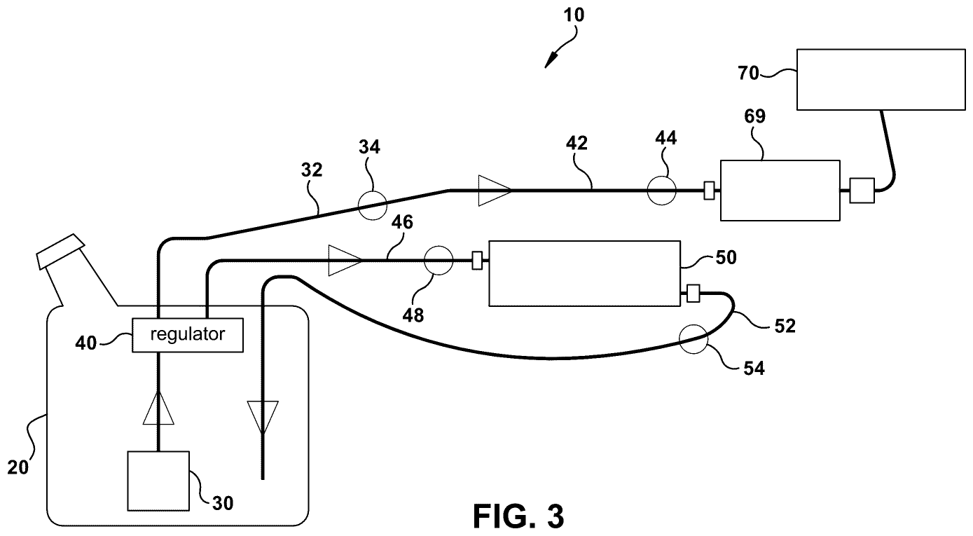

Referring next to FIG. 3, there is shown a fuel delivery system 10 for a work vehicle 100 in accordance with an illustrative embodiment of the present disclosure. As illustrated the fuel delivery system 10 includes a fuel tank 20, a primary fuel pump 30 disposed in the fuel tank 20, a fuel regulator device 40, and a fuel cooler device 50. The fuel tank 20 is operable to store fuel therein, and the primary fuel pump 30 is disposed in the fuel tank 20. The fuel regulator device 40 is operatively connected with the primary fuel pump 30 by a primary fuel delivery line 32. It is to be appreciated that the fuel may be #2 diesel fuel, ethanol fuel, or the like.

In the example embodiment the fuel regulator device 40 is operable to receive unregulated supply fuel 34 delivered to the fuel regulator device 40 from the primary fuel pump 30 via the primary fuel delivery line 32. The fuel regulator device 40 is further operable to control a property of the unregulated supply fuel 34 received from the primary fuel pump 30 for output from the fuel regulator device 40 as regulated fuel 44. The fuel regulator device 40 is further operable to deliver the regulated fuel 44 via a regulated fuel 44 delivery line to a secondary fuel pump 70 of the work vehicle 100.

An additional fuel filter 69 may be disposed in the regulated fuel delivery line 42 between the fuel regulator device 40 and the secondary fuel pump 70.

In the example embodiment the fuel delivery system may include a fuel filter (not shown in FIG. 3) operatively coupled with the primary fuel pump 30 for filtering the fuel as it flows from the fuel tank 20 and into the primary fuel pump 30. In addition, a check valve (not shown in FIG. 3) may be disposed in the primary fuel delivery line 32 between the primary fuel pump 30 and the fuel regulator device 40. The check valve when placed in this manner helps to prevent fuel from flowing in a reverse direction through the primary fuel pump 30 and back into the fuel tank 20.

As shown, the fuel cooler device 50 is operatively coupled with the fuel regulator device 40 by a fuel bypass line 46 and with the fuel tank 20 by a fuel return line 52.

In the example embodiment the fuel cooler device 50 is operable to receive bypass fuel 48 delivered to the fuel cooler device 50 from the fuel regulator device 40 via the fuel bypass line 46. In the example embodiment the fuel cooler device 50 is further operable to cool the bypass fuel 48 received by the fuel cooler device 50 to generate cooled bypass fuel 48, and to deliver the cooled bypass fuel 48 to the fuel tank 20 via the fuel return line 52.

It is to be appreciated that in the example embodiment illustrated, the fuel cooler device 50 provides a sole source of cooling to any fuel returned to the fuel tank 20 from the fuel delivery system 10 and the work vehicle 100.

In an example embodiment, the fuel cooler device 50 may comprise cooler tubes and a plurality of cooling fins coupled with the cooler tubes. In that way, the fuel cooler device 50 may cool the fuel passing therethrough by the external flow of air passing over and/or through the cooling fins.

In the example embodiment the fuel regulator device 40 is operable to deliver the regulated fuel 44 via the regulated fuel 44 delivery line to a secondary fuel pump 70 of the work vehicle 100 adapted to pressurize the regulated fuel 44 to a working pressure adapted for direct use by a spark ignited internal combustion engine 120 of the work vehicle 100.

In an example embodiment the fuel regulator device 40 is operable to control a pressure of the unregulated supply fuel 34 received from the primary fuel pump 30 for output from the fuel regulator device 40 to the secondary fuel pump 70 of the work vehicle 100 via the regulated fuel 44 delivery line as the regulated fuel 44. In this regard the fuel regulator device 40 is operable to receive the unregulated supply fuel 34 from the primary fuel pump 30 at a fuel pressure of the primary fuel pump and control the pressure of the unregulated supply fuel 34 received from the primary fuel pump 30 for output from the fuel regulator device 40 as the regulated fuel 44 having a fuel pressure within an acceptable operating pressure range. In this regard the fuel regulator device 40 is further operable to deliver the regulated fuel 44 having the pressure within the desired operating pressure range via the regulated fuel delivery line 42 to the secondary fuel pump 70 of the work vehicle 100, and to deliver to the fuel cooler device 50 all remaining portions of fuel received by the fuel regulator device 40 that are not delivered to the secondary fuel pump 70 of the work vehicle 100.

In an example embodiment the fuel regulator device 40 is operable to control a flow rate of the unregulated supply fuel 34 received from the primary fuel pump 30 for output from the fuel regulator device 40 to the secondary fuel pump 70 of the work vehicle 100 via the regulated fuel 44 delivery line as the regulated fuel 44. In this regard the fuel regulator device 40 is operable to receive the unregulated supply fuel 34 from the primary fuel pump 30 at a flow rate of about 160 liters per hour (lphr) and control the flow rate of the unregulated supply fuel 34 received from the primary fuel pump 30 for output from the fuel regulator device 40 as the regulated fuel 44 having a flow rate of about 60 lphr. In this regard the fuel regulator device 40 is further operable to deliver the regulated fuel 44 having the flow rate of about 60 lphr via the regulated fuel delivery line 42 to the secondary fuel pump 70 of the work vehicle 100, and deliver to the fuel cooler device 50 all remaining portions of fuel received by the fuel regulator device 40 that are not delivered to the secondary fuel pump 70 of the work vehicle 100.

In an example embodiment the fuel regulator device 40 is operable to control a pressure and flow rate of the unregulated supply fuel 34 received from the primary fuel pump 30 for output from the fuel regulator device 40 to the secondary fuel pump 70 of the work vehicle 100 via the regulated fuel 44 delivery line as the regulated fuel 44. In this regard the fuel regulator device 40 is operable to receive the unregulated supply fuel 34 from the primary fuel pump 30 at a pressure of the primary fuel pump and a flow rate of about 160 liters per hour (lphr) and control the pressure and flow rate of the unregulated supply fuel 34 received from the primary fuel pump 30 for output from the fuel regulator device 40 as the regulated fuel 44 having a pressure within a desired operating pressure range and a flow rate of about 60 lphr. In this regard the fuel regulator device 40 is further operable to deliver the regulated fuel 44 having a pressure within the desired operating pressure range and flow rate of about 60 lphr via the regulated fuel delivery line 42 to the secondary fuel pump 70 of the work vehicle 100, and deliver to the fuel cooler device 50 all remaining portions of fuel received by the fuel regulator device 40 that are not delivered to the secondary fuel pump 70 of the work vehicle 100.

In the example embodiment illustrated in FIG. 3 the fuel regulator device 40 is disposed in the fuel tank 20.

In the example embodiment the fuel delivery system may further include a fuel characteristic sensor (not shown in FIG. 3) for sensing a property of the fuel and generating a signal representative of the sensed property for delivery to an associated control system and/or device. In an example embodiment the fuel characteristic sensor may comprise a flex fuel sensor for sensing a percentage of alcohol in the fuel and generating a signal representative of the sensed percentage of alcohol in the fuel for delivery to an associated control system and/or device. The sensor may sense a percentage of methanol in the fuel, a percentage of ethanol in the fuel, a percentage of propanol in the fuel, a percentage of butanol in the fuel, or any other property or combination of properties of additives in the fuel. The fuel characteristic sensor 56 may be configured to determine for example whether the fuel is E93 type fuel or E98 type fuel for example and deliver a signal representative thereof to engine control device for optimizing operation of the work vehicle engine.

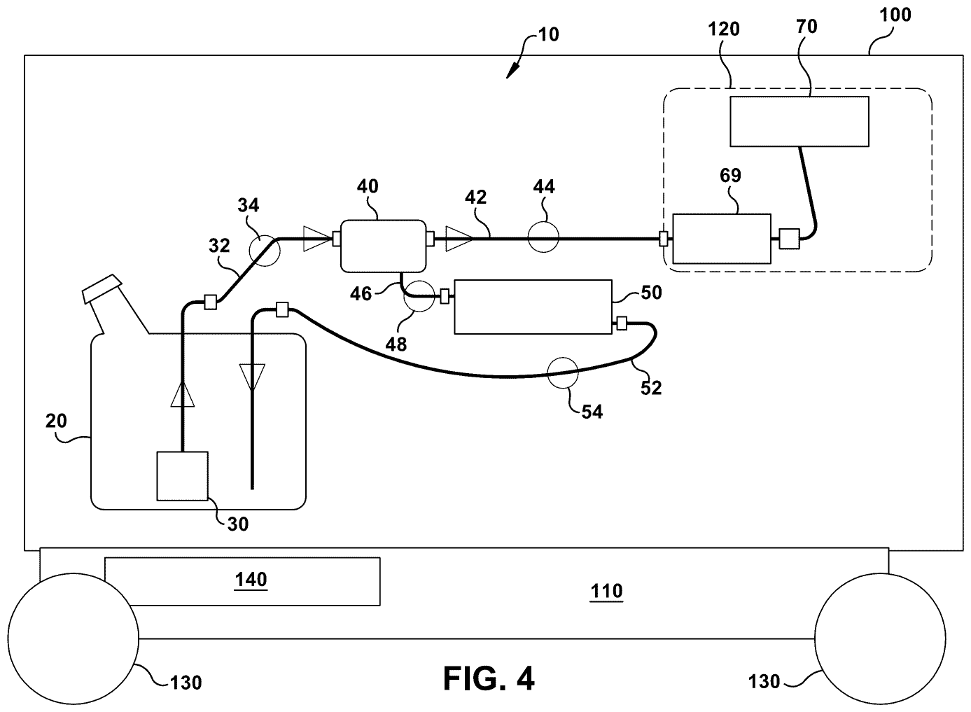

FIG. 4 is a schematic illustration of a work vehicle 100 having a fuel delivery system 10 in accordance with an example embodiment of the present disclosure. With reference now to that Figure the work vehicle 100 includes a chassis 110, a spark ignited internal combustion engine 120 operatively coupled with the chassis 110, one or more ground engaging members 130 configured to propel the work vehicle 100, a transmission system 140 coupling the spark ignited internal combustion engine 120 with the one or more ground engaging members 130, and a fuel delivery system 10. The one or more ground engaging members 130 may comprise tracks or wheels as shown, for example. It is to be appreciated that the fuel may be #2 diesel fuel, ethanol fuel, or the like.

In the embodiment illustrated, the fuel tank 20 of the work vehicle 100 is disposed immediately adjacent to the transmission system 140 of the work vehicle 100.

In the embodiment illustrated, the fuel tank 20 of the work vehicle 100 is disposed immediately adjacent and above the transmission system 140 of the work vehicle 100, whereby the fuel cooler device 50 of the fuel delivery system 10 of the work vehicle 100 provides a sole source of cooling to any fuel returned to the fuel tank 20 from the fuel delivery system 10 and the work vehicle 100 for cooling the fuel in the fuel tank 20 against increases of temperature of the fuel tank 20 caused by the immediate adjacency between the fuel tank 20 and the transmission system 140 of the work vehicle 100.

As illustrated the fuel delivery system 10 of the work vehicle 100 includes a fuel tank 20, a primary fuel pump 30 disposed in the fuel tank 20, a fuel regulator device 40, and a fuel cooler device 50. The fuel tank 20 is operable to store fuel therein, and the primary fuel pump 30 is disposed in the fuel tank 20. The fuel regulator device 40 is operatively connected with the primary fuel pump 30 by a primary fuel delivery line 32.

In the example embodiment the fuel regulator device 40 is operable to receive unregulated supply fuel 34 delivered to the fuel regulator device 40 from the primary fuel pump 30 via the primary fuel delivery line 32. The fuel regulator device 40 is further operable to control a property of the unregulated supply fuel 34 received from the primary fuel pump 30 for output from the fuel regulator device 40 as regulated fuel 44. The fuel regulator device 40 is further operable to deliver the regulated fuel 44 via a regulated fuel 44 delivery line to a secondary fuel pump 70 of the work vehicle 100.

As shown, the fuel cooler device 50 is operatively coupled with the fuel regulator device 40 by a fuel bypass line 46 and with the fuel tank 20 by a fuel return line 52.

In the example embodiment the fuel cooler device 50 is operable to receive bypass fuel 48 delivered to the fuel cooler device 50 from the fuel regulator device 40 via the fuel bypass line 46. In the example embodiment the fuel cooler device 50 is further operable to cool the bypass fuel 48 received by the fuel cooler device 50 to generate cooled bypass fuel 48, and to deliver the cooled bypass fuel 48 to the fuel tank 20 via the fuel return line 52.

It is to be appreciated that in the example embodiment illustrated, the fuel cooler device 50 provides a sole source of cooling to any fuel returned to the fuel tank 20 from the fuel delivery system 10 and the work vehicle 100.

In an example embodiment, the fuel cooler device 50 may comprise cooler tubes and a plurality of cooling fins coupled with the cooler tubes. In that way, the fuel cooler device 50 may cool the fuel passing therethrough by the external flow of air passing over and/or through the cooling fins.

In the example embodiment the fuel regulator device 40 is operable to deliver the regulated fuel 44 via the regulated fuel 44 delivery line to a secondary fuel pump 70 of the work vehicle 100 adapted to pressurize the regulated fuel 44 to a working pressure adapted for direct use by a spark ignited internal combustion engine 120 of the work vehicle 100.

In an example embodiment the fuel regulator device 40 is operable to control a pressure of the unregulated supply fuel 34 received from the primary fuel pump 30 for output from the fuel regulator device 40 to the secondary fuel pump 70 of the work vehicle 100 via the regulated fuel 44 delivery line as the regulated fuel 44. In this regard the fuel regulator device 40 is operable to receive the unregulated supply fuel 34 from the primary fuel pump 30 at a fuel pressure of the primary fuel pump and control the pressure of the unregulated supply fuel 34 received from the primary fuel pump 30 for output from the fuel regulator device 40 as the regulated fuel 44 having a fuel pressure within an acceptable operating pressure range. In this regard the fuel regulator device 40 is further operable to deliver the regulated fuel 44 having the pressure within the desired operating pressure range via the regulated fuel delivery line 42 to the secondary fuel pump 70 of the work vehicle 100, and to deliver to the fuel cooler device 50 all remaining portions of fuel received by the fuel regulator device 40 that are not delivered to the secondary fuel pump 70 of the work vehicle 100.

In an example embodiment the fuel regulator device 40 is operable to control a flow rate of the unregulated supply fuel 34 received from the primary fuel pump 30 for output from the fuel regulator device 40 to the secondary fuel pump 70 of the work vehicle 100 via the regulated fuel 44 delivery line as the regulated fuel 44. In this regard the fuel regulator device 40 is operable to receive the unregulated supply fuel 34 from the primary fuel pump 30 at a flow rate of about 160 liters per hour (lphr) and control the flow rate of the unregulated supply fuel 34 received from the primary fuel pump 30 for output from the fuel regulator device 40 as the regulated fuel 44 having a flow rate of about 60 lphr. In this regard the fuel regulator device 40 is further operable to deliver the regulated fuel 44 having the flow rate of about 60 lphr via the regulated fuel delivery line 42 to the secondary fuel pump 70 of the work vehicle 100, and deliver to the fuel cooler device 50 all remaining portions of fuel received by the fuel regulator device 40 that are not delivered to the secondary fuel pump 70 of the work vehicle 100.

In an example embodiment the fuel regulator device 40 is operable to control a pressure and flow rate of the unregulated supply fuel 34 received from the primary fuel pump 30 for output from the fuel regulator device 40 to the secondary fuel pump 70 of the work vehicle 100 via the regulated fuel 44 delivery line as the regulated fuel 44. In this regard the fuel regulator device 40 is operable to receive the unregulated supply fuel 34 from the primary fuel pump 30 at a pressure of the primary fuel pump and a flow rate of about 160 liters per hour (lphr) and control the pressure and flow rate of the unregulated supply fuel 34 received from the primary fuel pump 30 for output from the fuel regulator device 40 as the regulated fuel 44 having a pressure within a desired operating pressure range and a flow rate of about 60 lphr. In this regard the fuel regulator device 40 is further operable to deliver the regulated fuel 44 having a pressure within the desired operating pressure range and flow rate of about 60 lphr via the regulated fuel delivery line 42 to the secondary fuel pump 70 of the work vehicle 100, and deliver to the fuel cooler device 50 all remaining portions of fuel received by the fuel regulator device 40 that are not delivered to the secondary fuel pump 70 of the work vehicle 100.

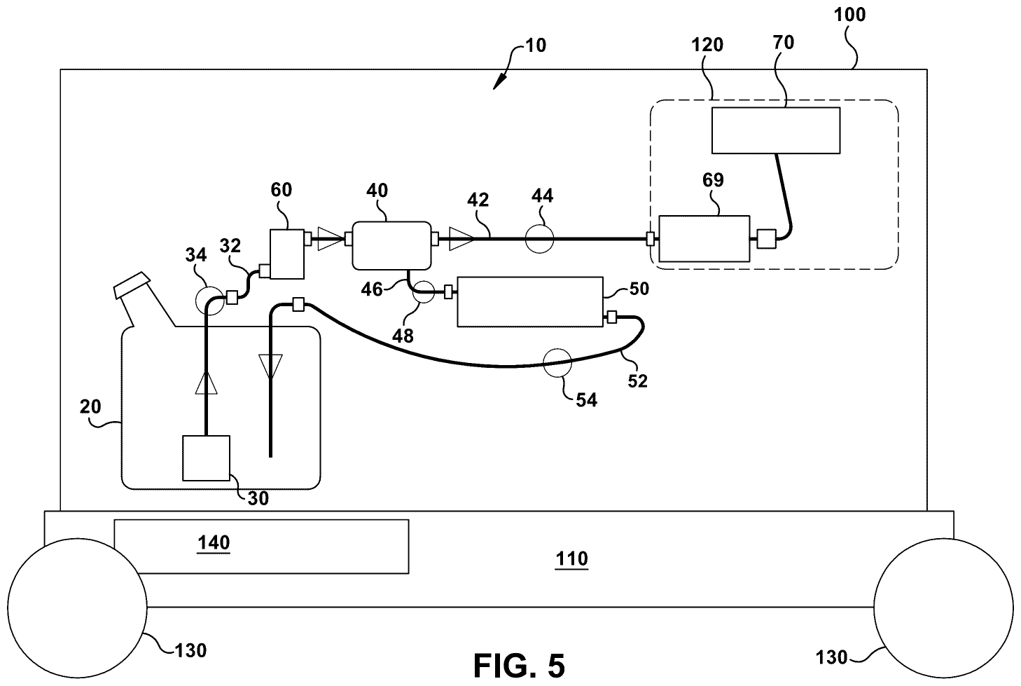

FIG. 5 is a schematic illustration of a work vehicle 100 having a fuel delivery system 10 in accordance with an example embodiment of the present disclosure. With reference now to that Figure as illustrated the work vehicle 100 includes a chassis 110, a spark ignited internal combustion engine 120 operatively coupled with the chassis 110, one or more ground engaging members 130 configured to propel the work vehicle 100, a transmission system 140 coupling the spark ignited internal combustion engine 120 with the one or more ground engaging members 130, and a fuel delivery system 10. The one or more ground engaging members 130 may comprise tracks or wheels as shown, for example. It is to be appreciated that the fuel may be #2 diesel fuel, ethanol fuel, or the like.

In the embodiment illustrated, the fuel tank 20 of the work vehicle 100 is disposed immediately adjacent to the transmission system 140 of the work vehicle 100.

In the embodiment illustrated, the fuel tank 20 of the work vehicle 100 is disposed immediately adjacent and above the transmission system 140 of the work vehicle 100, whereby the fuel cooler device 50 of the fuel delivery system 10 of the work vehicle 100 provides a sole source of cooling to any fuel returned to the fuel tank 20 from the fuel delivery system 10 and the work vehicle 100 for cooling the fuel in the fuel tank 20 against increases of temperature of the fuel tank 20 caused by the immediate adjacency between the fuel tank 20 and the transmission system 140 of the work vehicle 100.

The fuel delivery system 10 of the work vehicle 100 includes a fuel tank 20, a primary fuel pump 30 disposed in the fuel tank 20, a fuel regulator device 40, and a fuel cooler device 50. The fuel tank 20 is operable to store fuel therein, and the primary fuel pump 30 is disposed in the fuel tank 20. The fuel regulator device 40 is operatively connected with the primary fuel pump 30 by a primary fuel delivery line 32.

In the example embodiment the fuel regulator device 40 is operable to receive unregulated supply fuel 34 delivered to the fuel regulator device 40 from the primary fuel pump 30 via the primary fuel delivery line 32. The fuel regulator device 40 is further operable to control a property of the unregulated supply fuel 34 received from the primary fuel pump 30 for output from the fuel regulator device 40 as regulated fuel 44. The fuel regulator device 40 is further operable to deliver the regulated fuel 44 via a regulated fuel 44 delivery line to a secondary fuel pump 70 of the work vehicle 100.

As shown, the fuel cooler device 50 is operatively coupled with the fuel regulator device 40 by a fuel bypass line 46 and with the fuel tank 20 by a fuel return line 52.

In the example embodiment the fuel cooler device 50 is operable to receive bypass fuel 48 delivered to the fuel cooler device 50 from the fuel regulator device 40 via the fuel bypass line 46. In the example embodiment the fuel cooler device 50 is further operable to cool the bypass fuel 48 received by the fuel cooler device 50 to generate cooled bypass fuel 48, and to deliver the cooled bypass fuel 48 to the fuel tank 20 via the fuel return line 52.

It is to be appreciated that in the example embodiment illustrated, the fuel cooler device 50 provides a sole source of cooling to any fuel returned to the fuel tank 20 from the fuel delivery system 10 and the work vehicle 100.

In an example embodiment, the fuel cooler device 50 may comprise cooler tubes and a plurality of cooling fins coupled with the cooler tubes. In that way, the fuel cooler device 50 may cool the fuel passing therethrough by the external flow of air passing over and/or through the cooling fins.

In the example embodiment the fuel regulator device 40 is operable to deliver the regulated fuel 44 via the regulated fuel 44 delivery line to a secondary fuel pump 70 of the work vehicle 100 adapted to pressurize the regulated fuel 44 to a working pressure adapted for direct use by a spark ignited internal combustion engine 120 of the work vehicle 100.

In an example embodiment the fuel regulator device 40 is operable to control a pressure of the unregulated supply fuel 34 received from the primary fuel pump 30 for output from the fuel regulator device 40 to the secondary fuel pump 70 of the work vehicle 100 via the regulated fuel 44 delivery line as the regulated fuel 44. In this regard the fuel regulator device 40 is operable to receive the unregulated supply fuel 34 from the primary fuel pump 30 at a fuel pressure of the primary fuel pump and control the pressure of the unregulated supply fuel 34 received from the primary fuel pump 30 for output from the fuel regulator device 40 as the regulated fuel 44 having a fuel pressure within an acceptable operating pressure range. In this regard the fuel regulator device 40 is further operable to deliver the regulated fuel 44 having the pressure within the desired operating pressure range via the regulated fuel delivery line 42 to the secondary fuel pump 70 of the work vehicle 100, and to deliver to the fuel cooler device 50 all remaining portions of fuel received by the fuel regulator device 40 that are not delivered to the secondary fuel pump 70 of the work vehicle 100.

In an example embodiment the fuel regulator device 40 is operable to control a flow rate of the unregulated supply fuel 34 received from the primary fuel pump 30 for output from the fuel regulator device 40 to the secondary fuel pump 70 of the work vehicle 100 via the regulated fuel 44 delivery line as the regulated fuel 44. In this regard the fuel regulator device 40 is operable to receive the unregulated supply fuel 34 from the primary fuel pump 30 at a flow rate of about 160 liters per hour (lphr) and control the flow rate of the unregulated supply fuel 34 received from the primary fuel pump 30 for output from the fuel regulator device 40 as the regulated fuel 44 having a flow rate of about 60 lphr. In this regard the fuel regulator device 40 is further operable to deliver the regulated fuel 44 having the flow rate of about 60 lphr via the regulated fuel delivery line 42 to the secondary fuel pump 70 of the work vehicle 100, and deliver to the fuel cooler device 50 all remaining portions of fuel received by the fuel regulator device 40 that are not delivered to the secondary fuel pump 70 of the work vehicle 100.

In an example embodiment the fuel regulator device 40 is operable to control a pressure and flow rate of the unregulated supply fuel 34 received from the primary fuel pump 30 for output from the fuel regulator device 40 to the secondary fuel pump 70 of the work vehicle 100 via the regulated fuel 44 delivery line as the regulated fuel 44. In this regard the fuel regulator device 40 is operable to receive the unregulated supply fuel 34 from the primary fuel pump 30 at a pressure of the primary fuel pump and a flow rate of about 160 liters per hour (lphr) and control the pressure and flow rate of the unregulated supply fuel 34 received from the primary fuel pump 30 for output from the fuel regulator device 40 as the regulated fuel 44 having a pressure within a desired operating pressure range and a flow rate of about 60 lphr. In this regard the fuel regulator device 40 is further operable to deliver the regulated fuel 44 having a pressure within the desired operating pressure range and flow rate of about 60 lphr via the regulated fuel delivery line 42 to the secondary fuel pump 70 of the work vehicle 100, and deliver to the fuel cooler device 50 all remaining portions of fuel received by the fuel regulator device 40 that are not delivered to the secondary fuel pump 70 of the work vehicle 100.

In the example embodiment illustrated in FIG. 5 the fuel delivery system 10 further includes a fuel filter 60 disposed in the primary fuel delivery line 32 between the primary fuel pump 30 and the fuel regulator device 40. The fuel filter 60 is operable to filter the unregulated supply fuel 34 delivered to the fuel regulator device 40 from the primary fuel pump 30 via the primary fuel delivery line 32.

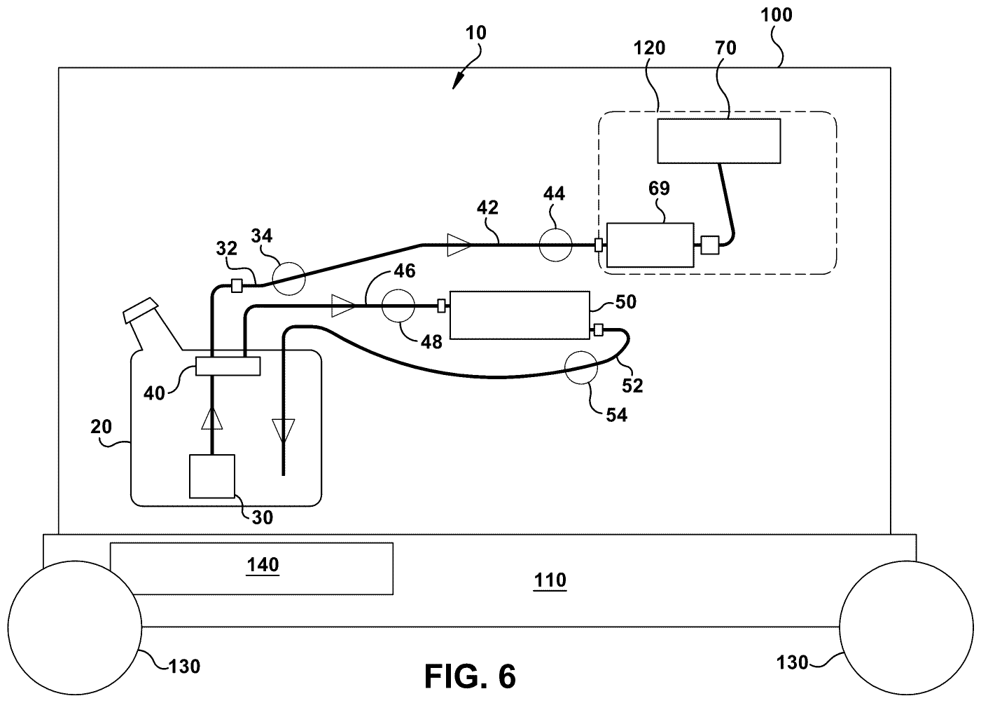

FIG. 6 is a schematic illustration of a work vehicle 100 having a fuel delivery system 10 in accordance with an example embodiment of the present disclosure. With reference now to that Figure as illustrated the work vehicle 100 includes a chassis 110, a spark ignited internal combustion engine 120 operatively coupled with the chassis 110, one or more ground engaging members 130 configured to propel the work vehicle 100, a transmission system 140 coupling the spark ignited internal combustion engine 120 with the one or more ground engaging members 130, and a fuel delivery system 10. The one or more ground engaging members 130 may comprise tracks or wheels as shown, for example. It is to be appreciated that the fuel may be #2 diesel fuel, ethanol fuel, or the like.

In the embodiment illustrated, the fuel tank 20 of the work vehicle 100 is disposed immediately adjacent to the transmission system 140 of the work vehicle 100.

In the embodiment illustrated, the fuel tank 20 of the work vehicle 100 is disposed immediately adjacent and above the transmission system 140 of the work vehicle 100, whereby the fuel cooler device 50 of the fuel delivery system 10 of the work vehicle 100 provides a sole source of cooling to any fuel returned to the fuel tank 20 from the fuel delivery system 10 and the work vehicle 100 for cooling the fuel in the fuel tank 20 against increases of temperature of the fuel tank 20 caused by the immediate adjacency between the fuel tank 20 and the transmission system 140 of the work vehicle 100.

With continued reference to FIG. 6, the fuel delivery system 10 of the work vehicle 100 includes a fuel tank 20, a primary fuel pump 30 disposed in the fuel tank 20, a fuel regulator device 40, and a fuel cooler device 50. The fuel tank 20 is operable to store fuel therein, and the primary fuel pump 30 is disposed in the fuel tank 20. The fuel regulator device 40 is operatively connected with the primary fuel pump 30 by a primary fuel delivery line 32.

In the example embodiment the fuel regulator device 40 is operable to receive unregulated supply fuel 34 delivered to the fuel regulator device 40 from the primary fuel pump 30 via the primary fuel delivery line 32. The fuel regulator device 40 is further operable to control a property of the unregulated supply fuel 34 received from the primary fuel pump 30 for output from the fuel regulator device 40 as regulated fuel 44. The fuel regulator device 40 is further operable to deliver the regulated fuel 44 via a regulated fuel 44 delivery line to a secondary fuel pump 70 of the work vehicle 100.

As shown, the fuel cooler device 50 is operatively coupled with the fuel regulator device 40 by a fuel bypass line 46 and with the fuel tank 20 by a fuel return line 52.

In the example embodiment the fuel cooler device 50 is operable to receive bypass fuel 48 delivered to the fuel cooler device 50 from the fuel regulator device 40 via the fuel bypass line 46. In the example embodiment the fuel cooler device 50 is further operable to cool the bypass fuel 48 received by the fuel cooler device 50 to generate cooled bypass fuel 48, and to deliver the cooled bypass fuel 48 to the fuel tank 20 via the fuel return line 52.

It is to be appreciated that in the example embodiment illustrated, the fuel cooler device 50 provides a sole source of cooling to any fuel returned to the fuel tank 20 from the fuel delivery system 10 and the work vehicle 100.

In an example embodiment, the fuel cooler device 50 may comprise cooler tubes and a plurality of cooling fins coupled with the cooler tubes. In that way, the fuel cooler device 50 may cool the fuel passing therethrough by the external flow of air passing over and/or through the cooling fins.

In the example embodiment the fuel regulator device 40 is operable to deliver the regulated fuel 44 via the regulated fuel 44 delivery line to a secondary fuel pump 70 of the work vehicle 100 adapted to pressurize the regulated fuel 44 to a working pressure adapted for direct use by a spark ignited internal combustion engine 120 of the work vehicle 100.

In an example embodiment the fuel regulator device 40 is operable to control a pressure of the unregulated supply fuel 34 received from the primary fuel pump 30 for output from the fuel regulator device 40 to the secondary fuel pump 70 of the work vehicle 100 via the regulated fuel 44 delivery line as the regulated fuel 44. In this regard the fuel regulator device 40 is operable to receive the unregulated supply fuel 34 from the primary fuel pump 30 at a fuel pressure of the primary fuel pump and control the pressure of the unregulated supply fuel 34 received from the primary fuel pump 30 for output from the fuel regulator device 40 as the regulated fuel 44 having a fuel pressure within an acceptable operating pressure range. In this regard the fuel regulator device 40 is further operable to deliver the regulated fuel 44 having the pressure within the desired operating pressure range via the regulated fuel delivery line 42 to the secondary fuel pump 70 of the work vehicle 100, and to deliver to the fuel cooler device 50 all remaining portions of fuel received by the fuel regulator device 40 that are not delivered to the secondary fuel pump 70 of the work vehicle 100.

In an example embodiment the fuel regulator device 40 is operable to control a flow rate of the unregulated supply fuel 34 received from the primary fuel pump 30 for output from the fuel regulator device 40 to the secondary fuel pump 70 of the work vehicle 100 via the regulated fuel 44 delivery line as the regulated fuel 44. In this regard the fuel regulator device 40 is operable to receive the unregulated supply fuel 34 from the primary fuel pump 30 at a flow rate of about 160 liters per hour (lphr) and control the flow rate of the unregulated supply fuel 34 received from the primary fuel pump 30 for output from the fuel regulator device 40 as the regulated fuel 44 having a flow rate of about 60 lphr. In this regard the fuel regulator device 40 is further operable to deliver the regulated fuel 44 having the flow rate of about 60 lphr via the regulated fuel delivery line 42 to the secondary fuel pump 70 of the work vehicle 100, and deliver to the fuel cooler device 50 all remaining portions of fuel received by the fuel regulator device 40 that are not delivered to the secondary fuel pump 70 of the work vehicle 100.

In an example embodiment the fuel regulator device 40 is operable to control a pressure and flow rate of the unregulated supply fuel 34 received from the primary fuel pump 30 for output from the fuel regulator device 40 to the secondary fuel pump 70 of the work vehicle 100 via the regulated fuel 44 delivery line as the regulated fuel 44. In this regard the fuel regulator device 40 is operable to receive the unregulated supply fuel 34 from the primary fuel pump 30 at a pressure of the primary fuel pump and a flow rate of about 160 liters per hour (lphr) and control the pressure and flow rate of the unregulated supply fuel 34 received from the primary fuel pump 30 for output from the fuel regulator device 40 as the regulated fuel 44 having a pressure within a desired operating pressure range and a flow rate of about 60 lphr. In this regard the fuel regulator device 40 is further operable to deliver the regulated fuel 44 having a pressure within the desired operating pressure range and flow rate of about 60 lphr via the regulated fuel delivery line 42 to the secondary fuel pump 70 of the work vehicle 100, and deliver to the fuel cooler device 50 all remaining portions of fuel received by the fuel regulator device 40 that are not delivered to the secondary fuel pump 70 of the work vehicle 100.

In the example embodiment illustrated in FIG. 6 the fuel regulator device 40 is disposed in the fuel tank 20.

It is to be appreciated that in each of the example embodiments of the work vehicle shown in FIGS. 4-6, an additional fuel filter may be disposed in the regulated fuel delivery line 42 between the fuel regulator device 40 and the secondary fuel pump 70.

In each of the example embodiments of the work vehicle shown in FIGS. 4-6, the fuel delivery system may include a fuel filter (not shown in FIGS. 4-6) operatively coupled with the primary fuel pump 30 for filtering the fuel as it flows from the fuel tank 20 and into the primary fuel pump 30. In addition, a check valve (not shown in FIGS. 4-6) may be disposed in the primary fuel delivery line 32 between the primary fuel pump 30 and the fuel regulator device 40. The check valve when placed in this manner helps to prevent fuel from flowing in a reverse direction through the primary fuel pump 30 and back into the fuel tank 20.

In each of the example embodiments of the work vehicle shown in FIGS. 4-6, the fuel delivery system may further include a fuel characteristic sensor (not shown in FIGS. 4-6) for sensing a property of the fuel and generating a signal representative of the sensed property for delivery to an associated control system and/or device. In an example embodiment the fuel characteristic sensor may comprise a flex fuel sensor for sensing a percentage of alcohol in the fuel and generating a signal representative of the sensed percentage of alcohol in the fuel for delivery to an associated control system and/or device. The sensor may sense a percentage of methanol in the fuel, a percentage of ethanol in the fuel, a percentage of propanol in the fuel, a percentage of butanol in the fuel, or any other property or combination of properties of additives in the fuel. The fuel characteristic sensor may be configured to determine for example whether the fuel is E93 type fuel or E98 type fuel for example and deliver a signal representative thereof to engine control device for optimizing operation of the work vehicle engine.

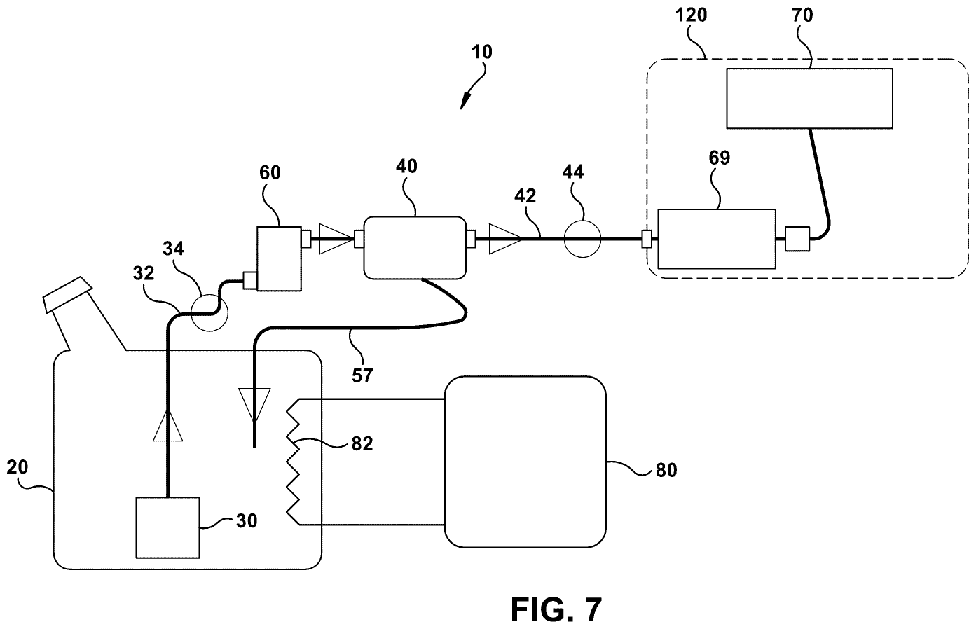

FIG. 7 is a schematic illustration of a fuel delivery system 10 in accordance with a further example embodiment of the present disclosure wherein the system 10 includes an auxiliary cooling system 80 in communication with a cooling coil 82 disposed in a fuel tank 20. In an example embodiment the heating, ventilation, and air conditioning (HVAC) system of the associated work vehicle 100 (not shown in FIG. 7) is used to also condition the fuel in the tank 20 for regulating the temperature of the fuel to within desired temperature bounds including for example to cool the fuel in the tank 20 to a desired temperature. In the system illustrated the coil may circulate a fluid such as a gas or a fluid to absorb heat from the fuel in the tank into the fluid circulating between the coil 82 and the auxiliary cooling system 80. The circulating fluid may be a refrigerant as an example. As a further example the circulating fluid may be glycol or any other liquid for absorbing heat from the fuel.

As illustrated the fuel delivery system 10 includes a fuel tank 20, a primary fuel pump 30 disposed in the fuel tank 20, a fuel regulator device 40. A separate fuel cooler device is not needed in the example embodiment illustrated in FIG. 7 since the auxiliary cooling system 80 may perform the function of providing a heat sink function. The fuel tank 20 is operable to store fuel therein, and the primary fuel pump 30 is disposed in the fuel tank 20. The fuel regulator device 40 is operatively connected with the primary fuel pump 30 by a primary fuel delivery line 32. It is to be appreciated that the fuel may be #2 diesel fuel, ethanol fuel, or the like.

In the example embodiment the fuel regulator device 40 is operable to receive unregulated supply fuel 34 delivered to the fuel regulator device 40 from the primary fuel pump 30 via the primary fuel delivery line 32. The fuel regulator device 40 is further operable to control a property of the unregulated supply fuel 34 received from the primary fuel pump 30 for output from the fuel regulator device 40 as regulated fuel 44. The fuel regulator device 40 is further operable to deliver the regulated fuel 44 via a regulated fuel 44 delivery line to a secondary fuel pump 70 of the work vehicle 100.

As shown an additional fuel filter 69 may be disposed in the regulated fuel delivery line 42 between the fuel regulator device 40 and the secondary fuel pump 70 of the spark ignited internal combustion engine 120.

In the example embodiment the fuel delivery system may include a fuel filter (not shown) operatively coupled with the primary fuel pump 30 for filtering the fuel as it flows from the fuel tank 20 and into the primary fuel pump 30. In addition, a check valve (not shown in FIG. 7) may be disposed in the primary fuel delivery line 32 between the primary fuel pump 30 and the fuel regulator device 40. The check valve when placed in this manner helps to prevent fuel from flowing in a reverse direction through the primary fuel pump 30 and back into the fuel tank 20.

As shown, the fuel regulator device 40 is operatively coupled with the fuel tank 20 by a fuel return line 57.

In the example embodiment the fuel regulator device 40 is operable to deliver the regulated fuel 44 via the regulated fuel 44 delivery line to a secondary fuel pump 70 of the work vehicle 100 adapted to pressurize the regulated fuel 44 to a working pressure adapted for direct use by a spark ignited internal combustion engine 120 of the work vehicle 100.

In an example embodiment the fuel regulator device 40 is operable to control a pressure of the unregulated supply fuel 34 received from the primary fuel pump 30 for output from the fuel regulator device 40 to the secondary fuel pump 70 of the work vehicle 100 via the regulated fuel 44 delivery line as the regulated fuel 44. In this regard the fuel regulator device 40 is operable to receive the unregulated supply fuel 34 from the primary fuel pump 30 at a fuel pressure of the primary fuel pump and control the pressure of the unregulated supply fuel 34 received from the primary fuel pump 30 for output from the fuel regulator device 40 as the regulated fuel 44 having a fuel pressure within an acceptable operating pressure range. In this regard the fuel regulator device 40 is further operable to deliver the regulated fuel 44 having the pressure within the desired operating pressure range via the regulated fuel delivery line 42 to the secondary fuel pump 70 of the work vehicle 100, and to deliver to the fuel tank 20 all remaining portions of fuel received by the fuel regulator device 40 that are not delivered to the secondary fuel pump 70 of the work vehicle 100.

In an example embodiment the fuel regulator device 40 is operable to control a flow rate of the unregulated supply fuel 34 received from the primary fuel pump 30 for output from the fuel regulator device 40 to the secondary fuel pump 70 of the work vehicle 100 via the regulated fuel 44 delivery line as the regulated fuel 44. In this regard the fuel regulator device 40 is operable to receive the unregulated supply fuel 34 from the primary fuel pump 30 at a flow rate of about 160 liters per hour (lphr) and control the flow rate of the unregulated supply fuel 34 received from the primary fuel pump 30 for output from the fuel regulator device 40 as the regulated fuel 44 having a flow rate of about 60 lphr. In this regard the fuel regulator device 40 is further operable to deliver the regulated fuel 44 having the flow rate of about 60 lphr via the regulated fuel delivery line 42 to the secondary fuel pump 70 of the work vehicle 100, and deliver to the fuel tank 20 all remaining portions of fuel received by the fuel regulator device 40 that are not delivered to the secondary fuel pump 70 of the work vehicle 100.

In an example embodiment the fuel regulator device 40 is operable to control a pressure and flow rate of the unregulated supply fuel 34 received from the primary fuel pump 30 for output from the fuel regulator device 40 to the secondary fuel pump 70 of the work vehicle 100 via the regulated fuel delivery line 42 as the regulated fuel 44. In this regard the fuel regulator device 40 is operable to receive the unregulated supply fuel 34 from the primary fuel pump 30 at a pressure of the primary fuel pump and a flow rate of about 160 liters per hour (lphr) and control the pressure and flow rate of the unregulated supply fuel 34 received from the primary fuel pump 30 for output from the fuel regulator device 40 as the regulated fuel 44 having a pressure within a desired operating pressure range and a flow rate of about 60 lphr. In this regard the fuel regulator device 40 is further operable to deliver the regulated fuel 44 having a pressure within the desired operating pressure range and flow rate of about 60 lphr via the regulated fuel delivery line 42 to the secondary fuel pump 70 of the work vehicle 100, and deliver to the fuel tank 20 all remaining portions of fuel received by the fuel regulator device 40 that are not delivered to the secondary fuel pump 70 of the work vehicle 100.

In the example embodiment illustrated in FIG. 2 the fuel delivery system 10 further includes a fuel filter 60 disposed in the primary fuel delivery line 32 between the primary fuel pump 30 and the fuel regulator device 40. The fuel filter 60 is operable to filter the unregulated supply fuel 34 delivered to the fuel regulator device 40 from the primary fuel pump 30 via the primary fuel delivery line 32.

In the example embodiment the fuel delivery system may further include a fuel characteristic sensor (not shown) for sensing a property of the fuel and generating a signal representative of the sensed property for delivery to an associated control system and/or device. In an example embodiment the fuel characteristic sensor may comprise a flex fuel sensor for sensing a percentage of alcohol in the fuel and generating a signal representative of the sensed percentage of alcohol in the fuel for delivery to an associated control system and/or device. The fuel characteristic sensor may sense a percentage of methanol in the fuel, a percentage of ethanol in the fuel, a percentage of propanol in the fuel, a percentage of butanol in the fuel, or any other property or combination of properties of additives in the fuel. The fuel characteristic sensor may be configured to determine for example whether the fuel is E93 type fuel or E98 type fuel for example and deliver a signal representative thereof to engine control device for optimizing operation of the work vehicle engine.

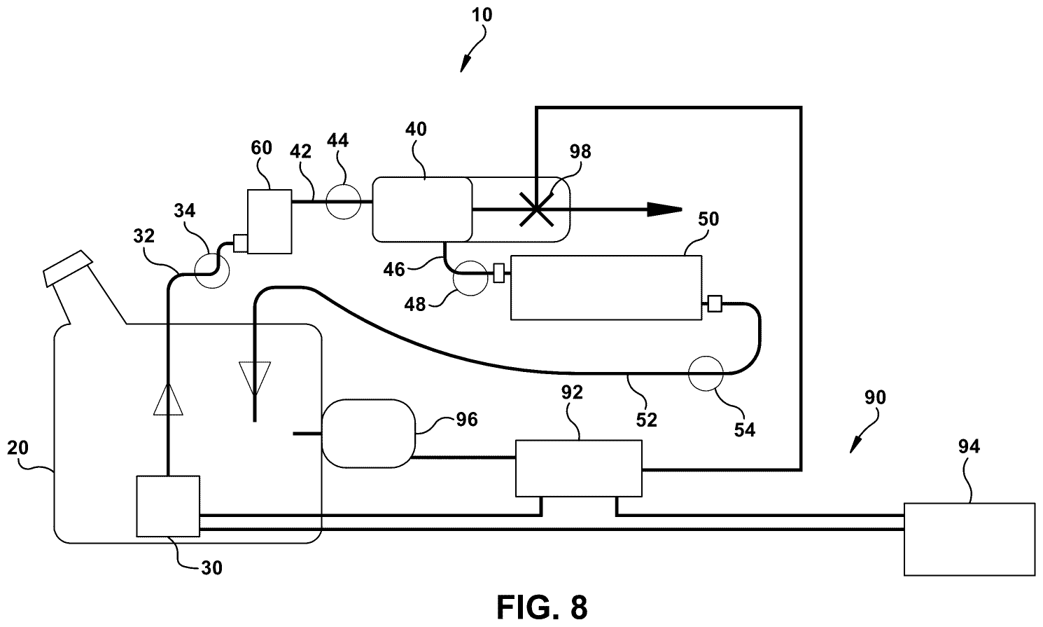

FIG. 8 is a schematic illustration of a fuel delivery system 10 in accordance with a further example embodiment of the present disclosure wherein the system 10 includes an auxiliary cooling control system 90 including a control unit 92 that is powered by a battery 94, and that is in operative communication with the fuel pump 30, a sensor 96, and a fuel shut off valve 98. The auxiliary cooling control system 90 may further include a processor device (not shown) in operative communication with a non-transient memory device (not shown) that stores control logic (not shown), wherein the processor device may execute the control logic to determine a temperature of the fuel stored within the tank 20 and to selectively energize the fuel pump 30 to circulate fuel through the fuel cooler device 50 based on the determined temperature. For example, the processor device may execute the control logic to selectively energize the fuel pump 30 to circulate fuel through the fuel cooler device 50 based on the determined temperature being above a predetermined temperature threshold. It is to be appreciated that the example embodiment illustrated in FIG. 8 is operable regardless of whether the spark ignited internal combustion engine of the work vehicle is operating. That is, the fuel delivery system 10 in accordance with the example embodiment illustrated in FIG. 8 may operate independently of any of the functions of the associated work vehicle.

As illustrated the fuel delivery system 10 includes a fuel tank 20, a primary fuel pump 30 disposed in the fuel tank 20, a fuel regulator device 40, and a fuel cooler device 50. The fuel tank 20 is operable to store fuel therein, and the primary fuel pump 30 is disposed in the fuel tank 20. The fuel regulator device 40 is operatively connected with the primary fuel pump 30 by a primary fuel delivery line 32. It is to be appreciated that the fuel may be #2 diesel fuel, ethanol fuel, or the like.

In the example embodiment the fuel regulator device 40 is operable to receive unregulated supply fuel 34 delivered to the fuel regulator device 40 from the primary fuel pump 30 via the primary fuel delivery line 32. The fuel regulator device 40 is further operable to control a property of the unregulated supply fuel 34 received from the primary fuel pump 30 for output from the fuel regulator device 40 as regulated fuel 44. The fuel regulator device 40 is further operable to deliver the regulated fuel 44 via a regulated fuel delivery line 42 to a secondary fuel pump (not shown) of the work vehicle.

An additional fuel filter (not shown) may be disposed in the regulated fuel delivery line 42 between the fuel regulator device 40 and the secondary fuel pump 70.

In the example embodiment the fuel delivery system may include a fuel filter (not shown) operatively coupled with the primary fuel pump 30 for filtering the fuel as it flows from the fuel tank 20 and into the primary fuel pump 30. In addition, a check valve (not shown) may be disposed in the primary fuel delivery line 32 between the primary fuel pump 30 and the fuel regulator device 40. The check valve when placed in this manner helps to prevent fuel from flowing in a reverse direction through the primary fuel pump 30 and back into the fuel tank 20.

As shown, the fuel cooler device 50 is operatively coupled with the fuel regulator device 40 by a fuel bypass line 46 and with the fuel tank 20 by a fuel return line 52.

In the example embodiment the fuel cooler device 50 is operable to receive bypass fuel 48 delivered to the fuel cooler device 50 from the fuel regulator device 40 via the fuel bypass line 46. In the example embodiment the fuel cooler device 50 is further operable to cool the bypass fuel 48 received by the fuel cooler device 50 to generate cooled bypass fuel 48, and to deliver the cooled bypass fuel 48 to the fuel tank 20 via the fuel return line 52.

It is to be appreciated that in the example embodiment illustrated, the fuel cooler device 50 provides a sole source of cooling to any fuel returned to the fuel tank 20 from the fuel delivery system 10 and the work vehicle 100.

In an example embodiment, the fuel cooler device 50 may comprise cooler tubes and a plurality of cooling fins coupled with the cooler tubes. In that way, the fuel cooler device 50 may cool the fuel passing therethrough by the external flow of air passing over and/or through the cooling fins.

In the example embodiment the fuel regulator device 40 is operable to deliver the regulated fuel 44 via the regulated fuel delivery line 42 to a secondary fuel pump 70 of the work vehicle 100 adapted to pressurize the regulated fuel 44 to a working pressure adapted for direct use by a spark ignited internal combustion engine 120 of the work vehicle 100.

In an example embodiment the fuel regulator device 40 is operable to control a pressure of the unregulated supply fuel 34 received from the primary fuel pump 30 for output from the fuel regulator device 40 to the secondary fuel pump 70 of the work vehicle 100 via the regulated fuel delivery line 42 as the regulated fuel 44. In this regard the fuel regulator device 40 is operable to receive the unregulated supply fuel 34 from the primary fuel pump 30 at a fuel pressure of the primary fuel pump and control the pressure of the unregulated supply fuel 34 received from the primary fuel pump 30 for output from the fuel regulator device 40 as the regulated fuel 44 having a fuel pressure within an acceptable operating pressure range. In this regard the fuel regulator device 40 is further operable to deliver the regulated fuel 44 having the pressure within the desired operating pressure range via the regulated fuel delivery line 42 to the secondary fuel pump 70 of the work vehicle 100, and to deliver to the fuel cooler device 50 all remaining portions of fuel received by the fuel regulator device 40 that are not delivered to the secondary fuel pump 70 of the work vehicle 100.

In an example embodiment the fuel regulator device 40 is operable to control a flow rate of the unregulated supply fuel 34 received from the primary fuel pump 30 for output from the fuel regulator device 40 to the secondary fuel pump 70 of the work vehicle 100 via the regulated fuel delivery line 42 as the regulated fuel 44. In this regard the fuel regulator device 40 is operable to receive the unregulated supply fuel 34 from the primary fuel pump 30 at a flow rate of about 160 liters per hour (lphr) and control the flow rate of the unregulated supply fuel 34 received from the primary fuel pump 30 for output from the fuel regulator device 40 as the regulated fuel 44 having a flow rate of about 60 lphr. In this regard the fuel regulator device 40 is further operable to deliver the regulated fuel 44 having the flow rate of about 60 lphr via the regulated fuel delivery line 42 to the secondary fuel pump 70 of the work vehicle 100, and deliver to the fuel cooler device 50 all remaining portions of fuel received by the fuel regulator device 40 that are not delivered to the secondary fuel pump 70 of the work vehicle 100.

In an example embodiment the fuel regulator device 40 is operable to control a pressure and flow rate of the unregulated supply fuel 34 received from the primary fuel pump 30 for output from the fuel regulator device 40 to the secondary fuel pump 70 of the work vehicle 100 via the regulated fuel delivery line 42 as the regulated fuel 44. In this regard the fuel regulator device 40 is operable to receive the unregulated supply fuel 34 from the primary fuel pump 30 at a pressure of the primary fuel pump and a flow rate of about 160 liters per hour (lphr) and control the pressure and flow rate of the unregulated supply fuel 34 received from the primary fuel pump 30 for output from the fuel regulator device 40 as the regulated fuel 44 having a pressure within a desired operating pressure range and a flow rate of about 60 lphr. In this regard the fuel regulator device 40 is further operable to deliver the regulated fuel 44 having a pressure within the desired operating pressure range and flow rate of about 60 lphr via the regulated fuel delivery line 42 to the secondary fuel pump 70 of the work vehicle 100, and deliver to the fuel cooler device 50 all remaining portions of fuel received by the fuel regulator device 40 that are not delivered to the secondary fuel pump 70 of the work vehicle 100.

In the example embodiment illustrated in FIG. 8 the fuel delivery system 10 further includes a fuel filter 60 disposed in the primary fuel delivery line 32 between the primary fuel pump 30 and the fuel regulator device 40. The fuel filter 60 is operable to filter the unregulated supply fuel 34 delivered to the fuel regulator device 40 from the primary fuel pump 30 via the primary fuel delivery line 32.

In the example embodiment the fuel delivery system may further include a fuel characteristic sensor (not shown) for sensing a property of the fuel and generating a signal representative of the sensed property for delivery to an associated control system and/or device. In an example embodiment the fuel characteristic sensor may comprise a flex fuel sensor for sensing a percentage of alcohol in the fuel and generating a signal representative of the sensed percentage of alcohol in the fuel for delivery to an associated control system and/or device. The sensor may sense a percentage of methanol in the fuel, a percentage of ethanol in the fuel, a percentage of propanol in the fuel, a percentage of butanol in the fuel, or any other property or combination of properties of additives in the fuel. The fuel characteristic sensor may be configured to determine for example whether the fuel is E93 type fuel or E98 type fuel for example and deliver a signal representative thereof to engine control device for optimizing operation of the work vehicle engine.

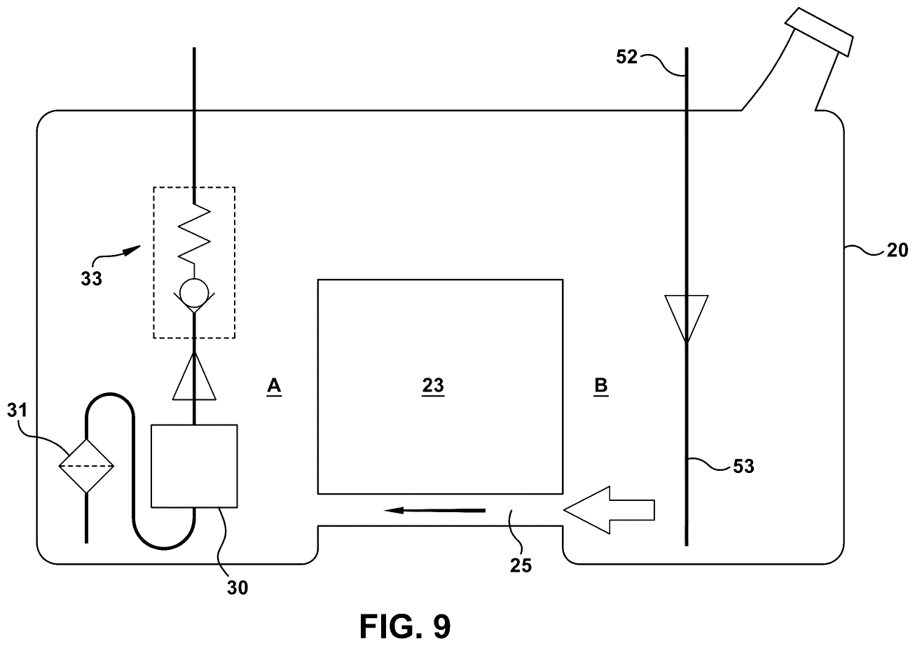

FIG. 9 is a schematic illustration of a fuel tank 20 of a fuel delivery system in accordance with an example embodiment of the present disclosure. In the example embodiment the fuel delivery system includes a fuel filter 31 operatively coupled with the primary fuel pump 30 for filtering the fuel as it flows from the fuel tank 20 and into the primary fuel pump 30. In addition, a check valve 33 is disposed in the primary fuel delivery line 32 between the primary fuel pump 30 and the fuel regulator device 40. Check valve 33 helps to prevent fuel from flowing in a reverse direction through the primary fuel pump 30 and back into the fuel tank 20.

The fuel tank 20 in the example embodiment has a generally annular conformation wherein an opening or hollow region 23 is defined generally centrally relative to the overall dimensions of the fuel tank 20. This in general divides the tank into larger reservoir regions A and B that are in fluid communication via a communication passageway 25. The fuel tank 20 may be a saddle tank that straddles a transmission of the associated work vehicle wherein the first reservoir A is located on one side of the transmission of the associated work vehicle, and the second reservoir B is located on the other or opposite side of the transmission of the associated work vehicle. The transmission may be disposed in general in the opening or hollow region 23.

In the illustrated example the fuel return line 52 defines a fuel return nozzle 53. It is to be appreciated that the fuel return nozzle 53 and the primary fuel pump 30 are disposed on opposite sides of the fuel tank 20. In particular, the primary fuel pump 30 is located in the first reservoir region A, and the fuel return nozzle 53 is located in the second reservoir region B. It is to be appreciated that sending and returning the fuel from and to opposite sides of the fuel tank as shown in FIG. 9 results in both an advantageous enhanced mixing of the fuel within the fuel tank 20 as well as an enhanced cooling of the fuel within the fuel tank 20. The fuel is in general rotated or “turned over” within the tank in a generally clockwise direction as viewed on the Figure by virtue of the primary fuel pump 30 being located in the first reservoir region A and the fuel return nozzle 53 being located in the second reservoir region B. This results in a minimization of temperature gradients within the tank. The example embodiment illustrated helps prevent a “hot” side of the tank and a “cold” side of the tank. As a result of the configuration of the example embodiment illustrated the fuel is essentially constantly “stirred” within the fuel tank 20 whenever the fuel pump 30 is activated since the fuel is returned via the fuel return line 52 downstream of the regulator 40 and injection back in to the tank by the fuel return nozzle 53.

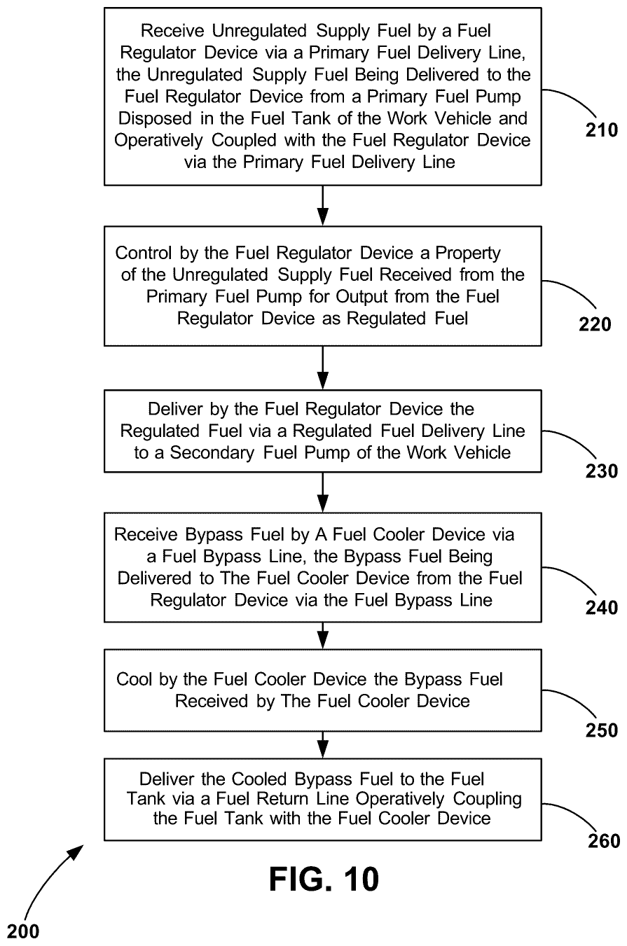

FIG. 10 is a flow diagram illustrating a method 200 of conditioning fuel stored in a fuel tank of a work vehicle is provided. The method 200 includes receiving 210 unregulated supply fuel by a fuel regulator device via a primary fuel delivery line, the unregulated supply fuel being delivered to the fuel regulator device from a primary fuel pump disposed in the fuel tank of the work vehicle and operatively coupled with the fuel regulator device via the primary fuel delivery line. It is to be appreciated that the fuel may be #2 diesel fuel, ethanol fuel, or the like.

The method 200 further includes controlling 220 by the fuel regulator device a property of the unregulated supply fuel received from the primary fuel pump for output from the fuel regulator device as regulated fuel.

The method 200 further includes delivering 230 by the fuel regulator device the regulated fuel via a regulated fuel delivery line to a secondary fuel pump of the work vehicle.

The method 200 further includes receiving 240 bypass fuel by a fuel cooler device via a fuel bypass line, the bypass fuel being delivered to the fuel cooler device from the fuel regulator device via the fuel bypass line.

The method 200 further includes cooling 250 by the fuel cooler device the bypass fuel received by the fuel cooler device.

The method 200 further includes delivering 260 the cooled bypass fuel to the fuel tank via a fuel return line operatively coupling the fuel tank with the fuel cooler device.

In an example embodiment, the cooling by the fuel cooler device the bypass fuel received by the fuel cooler device provides a sole source of cooling to any fuel returned to the fuel tank from the fuel delivery system and the work vehicle.

In an example embodiment, the cooling the bypass fuel comprises cooling the bypass fuel using a fuel cooler device comprising cooler tubes and a plurality of cooling fins coupled with the cooler tubes.

In an example embodiment the delivering the regulated fuel comprises delivering the regulated fuel by a fuel regulator device operable to deliver the regulated fuel via the regulated fuel delivery line to a secondary fuel pump of the work vehicle adapted to pressurize the regulated fuel to a working pressure adapted for use by a spark ignited internal combustion engine of the work vehicle.

In an example embodiment the method 200 further comprises controlling a pressure of the unregulated supply fuel by the fuel regulator device to control a pressure of the unregulated supply fuel received from the primary fuel pump for output from the fuel regulator device as the regulated fuel.

In an example embodiment, the method 200 further comprises operating the fuel regulator device to receive the unregulated supply fuel from the primary fuel pump at a fuel pressure of the primary fuel pump, control the pressure of the unregulated supply fuel received from the primary fuel pump for output from the fuel regulator device as the regulated fuel having a fuel pressure within an acceptable operating pressure range, deliver the regulated fuel having the pressure within the desired operating pressure range via the regulated fuel delivery line 42 to the secondary fuel pump of the work vehicle, and deliver to the fuel cooler device all remaining portions of fuel received by the fuel regulator device that are not delivered to the secondary fuel pump of the work vehicle.

In an example embodiment, the method further comprises controlling a flow rate of the unregulated supply fuel by the fuel regulator device to control a flow rate of the unregulated supply fuel received from the primary fuel pump for output from the fuel regulator device as the regulated fuel.

In an example embodiment, the method further comprises operating the fuel regulator device to receive the unregulated supply fuel from the primary fuel pump at a nominal flow rate of about 160 liters per hour (lphr), control the flow rate of the unregulated supply fuel received from the primary fuel pump for output from the fuel regulator device as the regulated fuel having a desired nominal flow rate of about 60 lphr, deliver the regulated fuel having the flow rate of about 60 lphr via the regulated fuel delivery line 42 to the secondary fuel pump of the work vehicle, and deliver to the fuel cooler device all remaining portions of fuel received by the fuel regulator device that are not delivered to the secondary fuel pump of the work vehicle.

In an example embodiment, the method further comprises using a fuel filter to filter the unregulated supply fuel delivered to the fuel regulator device from the primary fuel pump via the primary fuel delivery line.

In an example embodiment, the receiving the unregulated supply fuel by the fuel regulator device comprises receiving the unregulated supply fuel by a fuel regulator device disposed in the fuel tank.

It is to be understood that other embodiments will be utilized and structural and functional changes will be made without departing from the scope of the claims. The foregoing descriptions of embodiments have been presented for the purposes of illustration and description. It is not intended to be exhaustive or to limit the embodiments to the precise forms disclosed. Accordingly, many modifications and variations are possible in light of the above teachings. It is therefore intended that the scope of the claims not be limited by this detailed description.

1. A fuel delivery system for a work vehicle, the fuel delivery system comprising:
a fuel tank operable to store fuel therein;
a primary fuel pump disposed in the fuel tank;
a fuel regulator device operatively connected with the primary fuel pump by a primary fuel delivery line, the fuel regulator device being operable to:
receive unregulated supply fuel delivered to the fuel regulator device from the primary fuel pump via the primary fuel delivery line;
control a property of the unregulated supply fuel received from the primary fuel pump for output from the fuel regulator device as regulated fuel; and
deliver the regulated fuel via a regulated fuel delivery line to a secondary fuel pump of the work vehicle; and
a fuel cooler device operatively coupled with the fuel regulator device by a fuel bypass line and with the fuel tank by a fuel return line, the fuel cooler device being operable to:
receive bypass fuel delivered to the fuel cooler device from the fuel regulator device via the fuel bypass line;
cool the bypass fuel received by the fuel cooler device to generate cooled bypass fuel; and
deliver the cooled bypass fuel to the fuel tank via the fuel return line.

2. The fuel delivery system according to claim 1, wherein:
the fuel cooler device provides a sole source of cooling to any fuel returned to the fuel tank from the fuel delivery system and the work vehicle.

3. The fuel delivery system according to claim 1, wherein the fuel cooler device comprises:
cooler tubes; and
a plurality of cooling fins coupled with the cooler tubes.

4. The fuel delivery system according to claim 1, wherein:
the fuel regulator device is operable to deliver the regulated fuel via the regulated fuel delivery line to a secondary fuel pump of the work vehicle adapted to pressurize the regulated fuel to a working pressure adapted for direct use by a spark ignited internal combustion engine of the work vehicle.

5. The fuel delivery system according to claim 1, wherein:
the fuel regulator device is operable to control a pressure of the unregulated supply fuel received from the primary fuel pump for output from the fuel regulator device to the secondary fuel pump of the work vehicle via the regulated fuel delivery line as the regulated fuel.

6. The fuel delivery system according to claim 1, wherein:
the fuel regulator device is operable to control a flow rate of the unregulated supply fuel received from the primary fuel pump for output from the fuel regulator device to the secondary fuel pump of the work vehicle via the regulated fuel delivery line as the regulated fuel.

7. A work vehicle comprising:
a chassis;
a spark ignited internal combustion engine operatively coupled with the chassis;
one or more ground engaging members configured to propel the work vehicle;
a transmission system coupling the spark ignited internal combustion engine with the one or more ground engaging members; and
a fuel delivery system comprising:
a fuel tank operable to store fuel therein;
a primary fuel pump disposed in the fuel tank;
a fuel regulator device operatively connected with the primary fuel pump 30 by a primary fuel delivery line, the fuel regulator device 40 being operable to:
receive unregulated supply fuel delivered to the fuel regulator device from the primary fuel pump via the primary fuel delivery line;
control a property of the unregulated supply fuel received from the primary fuel pump for output from the fuel regulator device as regulated fuel; and
deliver the regulated fuel via a regulated fuel delivery line to a secondary fuel pump of the work vehicle;
a fuel cooler device operatively coupled with the fuel regulator device by a fuel bypass line and with the fuel tank by a fuel return line, the fuel cooler device being operable to:
receive bypass fuel delivered to the fuel cooler device from the fuel regulator device via the fuel bypass line;
cool the bypass fuel received by the fuel cooler device; and
deliver the cooled bypass fuel to the fuel tank via the fuel return line.

8. The work vehicle according to claim 7, wherein:
the fuel cooler device of the fuel delivery system of the work vehicle provides a sole source of cooling to any fuel returned to the fuel tank from the fuel delivery system and the work vehicle.

9. The work vehicle according to claim 7, wherein:
the fuel cooler device of the fuel delivery system of the work vehicle comprises cooler tubes, and a plurality of cooling fins coupled with the cooler tubes.

10. The work vehicle according to claim 7, wherein:
the fuel regulator device of the fuel delivery system of the work vehicle is operable to deliver the regulated fuel via the regulated fuel delivery line to a secondary fuel pump of the work vehicle; and
the secondary fuel pump of the work vehicle is operable to pressurize the regulated fuel to a working pressure adapted for direct use by the spark ignited internal combustion engine of the work vehicle.

11. The work vehicle according to claim 7, wherein:
the fuel regulator device of the fuel delivery system of the work vehicle is operable to control a pressure of the unregulated supply fuel received from the primary fuel pump for output from the fuel regulator device to the secondary fuel pump of the work vehicle via the regulated fuel delivery line as the regulated fuel.

12. The work vehicle according to claim 7, wherein:
the fuel regulator device of the fuel delivery system of the work vehicle is operable to control a flow rate of the unregulated supply fuel received from the primary fuel pump for output from the fuel regulator device to the secondary fuel pump of the work vehicle via the regulated fuel delivery line as the regulated fuel.

13. The work vehicle according to claim 7, wherein:
the fuel tank of the work vehicle is disposed immediately adjacent to the transmission system of the work vehicle.

14. The work vehicle according to claim 7, wherein:
the fuel tank of the work vehicle is disposed immediately adjacent and above the transmission system of the work vehicle, whereby the fuel cooler device of the fuel delivery system of the work vehicle provides a sole source of cooling to any fuel returned to the fuel tank from the fuel delivery system and the work vehicle for cooling the fuel in the fuel tank against increases of temperature of the fuel tank caused by the immediate adjacency between the fuel tank and the transmission system of the work vehicle.

15. A method of conditioning fuel stored in a fuel tank of a work vehicle, the method comprising:
receiving unregulated supply fuel by a fuel regulator device via a primary fuel delivery line, the unregulated supply fuel being delivered to the fuel regulator device from a primary fuel pump disposed in the fuel tank of the work vehicle and operatively coupled with the fuel regulator device via the primary fuel delivery line;
controlling by the fuel regulator device a property of the unregulated supply fuel received from the primary fuel pump for output from the fuel regulator device as regulated fuel;
delivering by the fuel regulator device the regulated fuel via a regulated fuel delivery line to a secondary fuel pump of the work vehicle;
receiving bypass fuel by a fuel cooler device via a fuel bypass line, the bypass fuel being delivered to the fuel cooler device from the fuel regulator device via the fuel bypass line;
cooling by the fuel cooler device the bypass fuel received by the fuel cooler device; and
delivering the cooled bypass fuel to the fuel tank via a fuel return line operatively coupling the fuel tank with the fuel cooler device.

16. The method according to claim 15, wherein:
the cooling by the fuel cooler device of the bypass fuel received by the fuel cooler device provides a sole source of cooling to any fuel returned to the fuel tank from the fuel delivery system and the work vehicle.

17. The method according to claim 15, wherein:
the cooling by the bypass fuel comprises cooling the bypass fuel using a fuel cooler device comprising cooler tubes and a plurality of cooling fins coupled with the cooler tubes.

18. The method according to claim 15, wherein:
the delivering the regulated fuel comprises delivering the regulated fuel by a fuel regulator device operable to deliver the regulated fuel via the regulated fuel delivery line to a secondary fuel pump of the work vehicle adapted to pressurize the regulated fuel to a working pressure adapted for use by a spark ignited internal combustion engine of the work vehicle.

19. The method according to claim 15, further comprising:
controlling a pressure of the unregulated supply fuel by the fuel regulator device to control a pressure of the unregulated supply fuel received from the primary fuel pump for output from the fuel regulator device to the secondary fuel pump of the work vehicle via the regulated fuel delivery line as the regulated fuel.

20. The method according to claim 15, further comprising:
controlling a flow rate of the unregulated supply fuel by the fuel regulator device to control a flow rate of the unregulated supply fuel received from the primary fuel pump for output from the fuel regulator device to the secondary fuel pump of the work vehicle via the regulated fuel delivery line as the regulated fuel.
